(19) United States
(12) Patent Application Publication
(10) Pub. No.: US 2026/0193448 A1
(43) Pub. Date: Jul. 9, 2026

(54) POLYCARBONATE COMPOSITION CONTAINING COMBINATION OF HYDROXYPHENYL TRIAZINES AND UV ABSORBERS

(71) Applicant: BASF SE, Ludwigshafen am Rhein (DE)

(72) Inventors: Tania WEYLAND, Kaisten (CH); Heinz HERBST, Kaisten (CH); Daniel MUELLER, Kaisten (CH); Jorge ESPINOS ARIZTI, Barcelona (ES); Michèle GERSTER, Basel (CH)

(21) Appl. No.: 18/868,049

(22) PCT Filed: May 19, 2023
(86) PCT No.: PCT/EP2023/063450

§ 371 Date: Nov. 21, 2024

(30) Foreign Application Priority Data
May 24, 2022 (EP) 22175013.6

(51) Int. Cl. C08K 5/3492; C08K 5/315; C08K 5/3475; C08K 5/526

(52) U.S. Cl. CPC C08K 5/3492; C08K 5/315; C08K 5/3475; C08K 5/526

(57) ABSTRACT

The present invention relates to a composition comprising a polycarbonate, at least one compound of formula (A), and at least one UV absorber, other than the compound of formula (A). Further, the present invention relates to an additive mixture comprising at least one compound of formula (A), and at least one UV absorber. The present invention also relates to the use of the additive mixture for enhancing optical properties of the molded or extruded articles, including multilayered articles.

### FIELD OF THE INVENTION

The present invention relates to a composition comprising a polycarbonate, at least one compound of formula (A), and at least one UV absorber, other than the compound of formula (A). Further, the present invention relates to an additive mixture comprising at least one compound of formula (A), and at least one UV absorber. The present invention also relates to the use of the additive mixture for enhancing optical properties of the molded or extruded articles, including multilayered articles.

### BACKGROUND OF THE INVENTION

Polycarbonate molded or extruded articles are known in the literature and are prepared for a large number of applications. These articles are produced e.g. by extruding compositions that contain polycarbonate. Coextrusion with other compositions that contain polycarbonate and, in addition, a relatively high proportion of UV absorbers may optionally take place. However, polycarbonate has the disadvantage that it is not itself inherently UV-stable.

To prevent the detrimental effects of UV light on the articles prepared from the polycarbonate, different additives for eg. hindered amine light stabilizers, UV absorbers, etc are used. However, these additives or mixture of these additives are not able to improve the stability of the polycarbonate molded or extruded articles to a greater extent.

Thus, an object of the present invention is to overcome the above-mentioned drawbacks and to provide a polycarbonate comprising composition with improved optical properties. It is especially desirable to improve the optical properties of polycarbonate sheets and polycarbonate articles.

Another object of the present invention is to provide a polycarbonate composition that can be used to prepare polycarbonate articles or sheets with improves optical properties, especially Delta E and Yellowness index.

Yet another object of the present invention is to provide the composition that improves the weathering resistance of the polycarbonate sheets or articles.

Yet another object of the present invention is to provide an additive mixture which can improve the optical properties of polycarbonate when incorporated into polycarbonate.

### SUMMARY OF THE INVENTION

Surprisingly, it has been found that the additive mixture of the presently claimed invention i.e., combination of at least one compound of formula (A), at least one UV absorber, other than the compound of formula (A), and a polycarbonate improves optical properties of the polycarbonate sheets or polycarbonate articles, which is exposed to light, and thus prolongs the lifetime of the polycarbonate sheets or polycarbonate articles and that results in economic value.

Thus, in one aspect, the presently claimed invention is directed to a composition comprising:
i. a polycarbonate in an amount in the range of 90 to 99.9 wt % based on the total weight of the composition;
ii. at least one compound of formula (A) selected from the formulae (A-1), (A-2), (A-3), (A-4), (A-5), (A-6), or (A-7), in an amount in the range of 0.02 to 0.8 wt % based on the total weight of the composition,

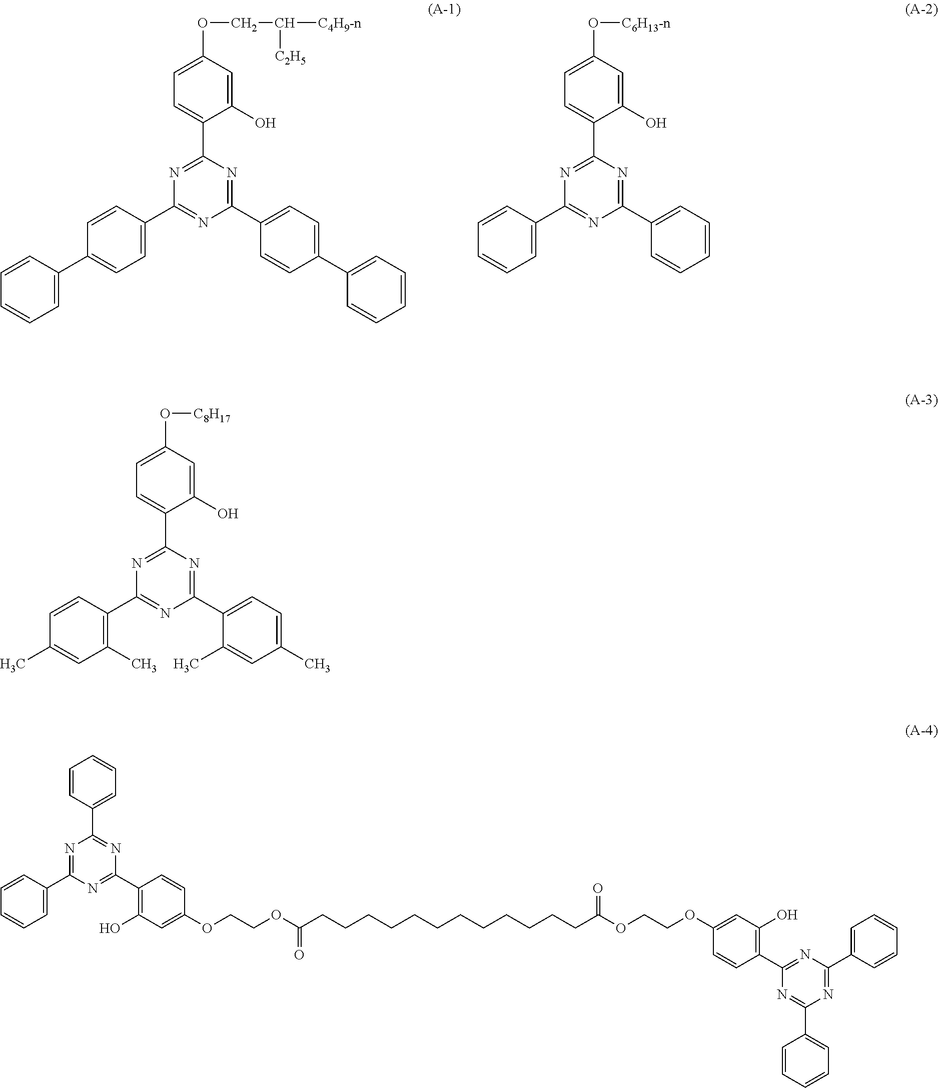

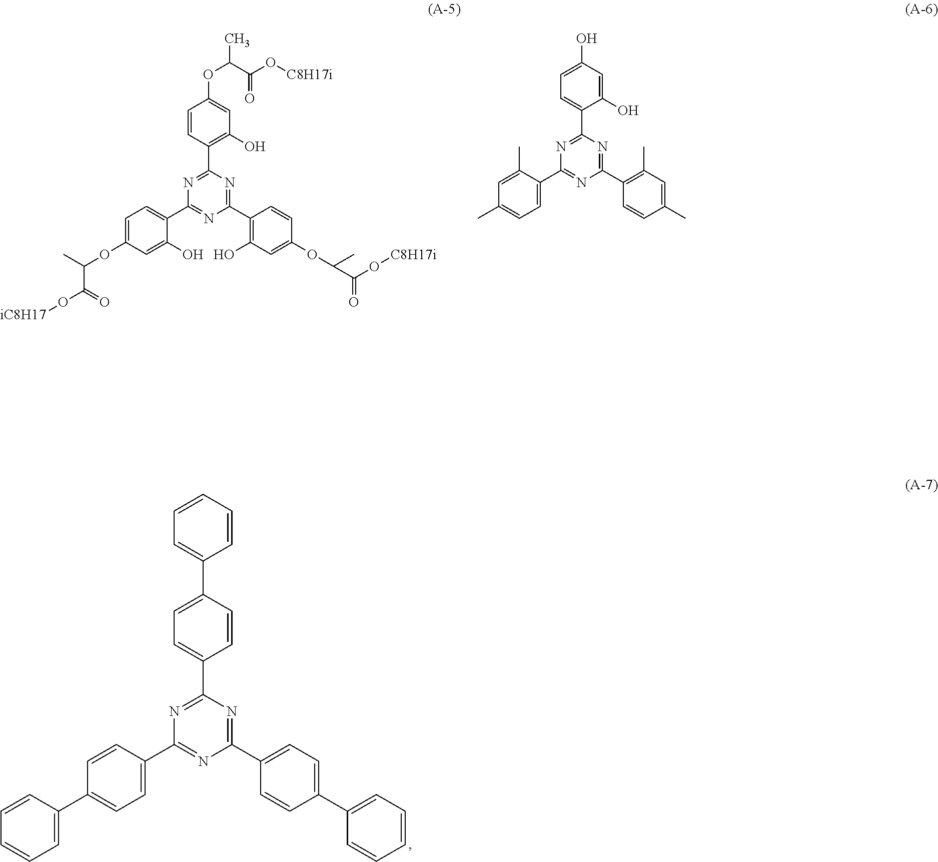

and
iii. at least one UV absorber, other than the compound of formula (A), in an amount in the range of 0.4 to 2.5 wt % based on the total weight of the composition.

In another aspect, the presently claimed invention is directed to an additive mixture comprising
I. at least one compound of formula (A) as defined above; and
II. at least one UV absorber, other than the compound of formula (A).

In another aspect, the presently claimed invention is directed to an article comprising the composition, as defined above.

In yet another aspect, the presently claimed invention is directed to use of the additive mixture, as defined above, for enhancing optical properties of the molded or extruded articles, including multilayered articles.

### DETAILED DESCRIPTION OF THE INVENTION

Before the present compositions and formulations of the invention are described, it is to be under-stood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless other-wise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “a preferred embodiment” means that a particular feature, structure or characteristic described in connection with the embodiment is included in at least one embodiment of the presently claimed invention. Thus, appearances of the phrases “in one embodiment” or “in a preferred embodiment” or “in another embodiment” in various places throughout this specification are not necessarily all referring to the same embodiment but may. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a composition comprising:
i. a polycarbonate;
ii. at least one compound of formula (A),

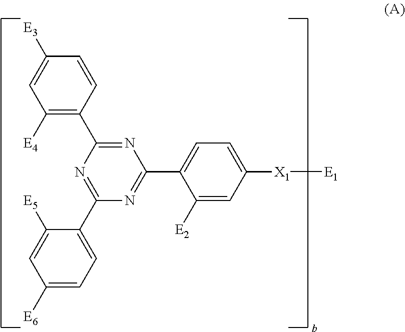

wherein
E₁ is hydrogen, C₁-C₁₈ alkyl, a group of formula P

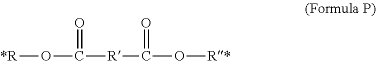

wherein, R, R′ and R″ independently of one another are C₁-C₁₈ alkylene,
* denotes point of attachment to X₁,
or
a group of Formula Q

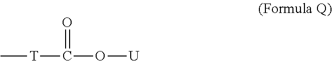

wherein, T is linear or branched C₁-C₁₈ alkylene and U is linear or branched C₁-C₁₈ alkyl,
E₂ is a hydrogen, hydroxyl, alkoxy, phenyl, or phenyl substituted by 1, 2 or 3 C₁-C₄ alkyl,
E₃, E₄, E₅, and E₆ independently of one another are hydrogen, C₁-C₁₈ alkyl, phenyl or phenyl substituted by 1, 2 or 3 C₁-C₄alkyl, or a group of Formula Q

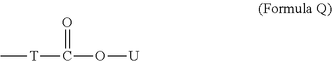

wherein, T is a linear or branched C₁-C₁₈ alkylene and U is linear or branched C₁-C₁₈ alkyl,
X₁ is a direct bond oxygen, phenyl, or phenyl substituted by 1, 2 or 3 C₁-C₄alkyl, and
b is an integer in the range of 1 to 2, and
iii. at least one UV absorber, other than the compound of formula (A).

In a preferred embodiment, the presently claimed invention is directed to a composition comprising:
i. a polycarbonate in an amount in the range of 90 to 99.9 wt % based on the total weight of the composition;
ii. at least one compound of formula (A) in an amount in the range of 0.02 to 1 wt % based on the total weight of the composition,

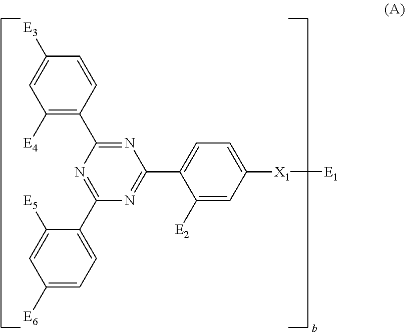

wherein
E₁ is hydrogen, C₁-C₁₈ alkyl, a group of formula P

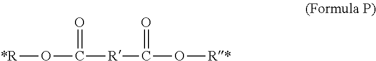

wherein, R, R′ and R″ independently of one another are C₁-C₁₈ alkylene,
* denotes point of attachment to X₁,
or
a group of Formula Q

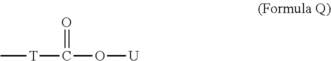

wherein, T is linear or branched C₁-C₁₈ alkylene and U is linear or branched C₁-C₁₈ alkyl,
E₂ is hydrogen, hydroxyl, alkoxy, phenyl, or phenyl substituted by 1, 2 or 3 C₁-C₄ alkyl,
E₃, E₄, E₅, and E₆ independently of one another are hydrogen, C₁-C₁₈ alkyl, phenyl or phenyl substituted by 1, 2 or 3 C₁-C₄alkyl, or a group of Formula Q

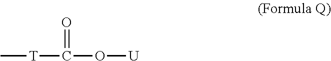

wherein, T is a linear or branched C₁-C₁₈ alkylene and U is linear or branched C₁-C₁₈ alkyl,
X₁ is a direct bond oxygen, phenyl, or phenyl substituted by 1, 2 or 3 C₁-C₄alkyl, and
b is an integer in the range of 1 to 2, and
iii. at least one UV absorber, other than the compound of formula (A), in an amount in the range of 0.1 to 10 wt % based on the total weight of the composition.

In a preferred embodiment, the polycarbonate is selected from homopolycarbonates, copolycarbonates, thermoplastic polyester carbonates, polycarbonate/acrylonitrile-butadiene-styrene terpolymer blend, thermoplastic alloy of polycarbonate/acrylic-styrene-acrylonitrile terpolymer, thermoplastic alloy blend of polycarbonate/polybutylene terephthalate, thermoplastic alloy of polycarbonate/polyethylene terephthalate, or thermoplastic alloy of polycarbonate and styrene-acrylonitrile.

In a more preferred embodiment, the polycarbonate is selected from homopolycarbonates, copolycarbonates, thermoplastic polyester carbonates, polycarbonate/acrylonitrile-butadiene-styrene terpolymer blend, thermoplastic alloy of polycarbonate/acrylic-styrene-acrylonitrile terpolymer, or thermoplastic alloy blend of polycarbonate/polybutylene terephthalate.

In a most preferred embodiment, the polycarbonate is selected from homopolycarbonates, copolycarbonates, thermoplastic polyester carbonates, or polycarbonate/acrylonitrile-butadiene-styrene terpolymer blend.

In a preferred embodiment, the total amount of polycarbonate in the composition is in the range of 90 to 99.9 wt % based on the total weight of the composition.

In a more preferred embodiment, the total amount of polycarbonate in the composition is in the range of 91 to 99.8 wt %, or 92 to 99.7 wt %, or 93 to 99.6 wt %, or 94 to 99.5 wt %, or 95 to 99.4 wt %, or 96 to 99.3 wt %, based on the total weight of the composition.

In a most preferred embodiment, the total amount of polycarbonate in the composition is in the range of 97 to 99.2 wt % based on the total weight of the composition.

Within the context of the present invention, the term alkyl, as used herein, refers to acyclic saturated aliphatic residues, including linear or branched alkyl residues.

As used herein, “branched” denotes a chain of atoms with one or more side chains attached to it. Branching occurs by the replacement of a substituent, e.g., a hydrogen atom, with a covalently bonded aliphatic moiety.

### Compound of Formula (A):

In a preferred embodiment, the composition comprises at least one compound of formula (A)

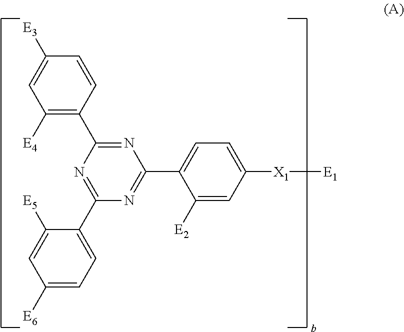

In a preferred embodiment, E₁ is hydrogen, C₁-C₁₈ alkyl, a group of Formula P, or a group of Formula Q, more preferably hydrogen, C₁-C₈ alkyl, a group of formula P

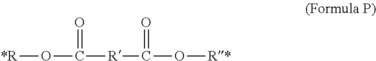

wherein, R, R′ and R″ independently of one another are C₁-C₁₈ alkylene, more preferably R, R′ and R″ independently of one another are C₂-C₁₀ alkylene, preferably b is an integer in the range of 1 to 2, or a group of formula Q.

In a preferred embodiment, when b is 1 then E₁ is hydrogen, alkyl, or a group of Formula Q and when b is 2 then E₁ is group of formula P.

In a preferred embodiment, E₂ is hydrogen, hydroxyl, alkoxy, phenyl, or phenyl substituted by 1, 2, or 3 C₁-C₄alkyl, more preferably E₂ is hydrogen, or hydroxyl.

In a preferred embodiment, E₃, E₄, E₅, and E₆ independently of one another are hydrogen, C₁-C₁₈ alkyl, phenyl or phenyl substituted by 1, 2 or 3 C₁-C₄alkyl, or a group of Formula Q, more preferably E₃, E₄, E₅, and E₆ independently of one another are hydrogen, C₁-C₄ alkyl, phenyl, or a group of formula Q.

Examples of alkyl having up to 18 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl. Examples of alkylene having up to 18 carbon atoms are methylene, ethylene, propylene, isopropylene, n-butylene, sec-butylene, isobutylene, tert-butylene, 2-ethylbutylene, n-pentylene, isopentylene, 1-methylpentylene, 1,3-dimethylbutylene, n-hexylene, 1-methylhexylene, n-heptylene, isoheptylene, 1,1,3,3-tetramethylbutylene, 1-methylheptylene, 3-methylheptylene, n-octylene, 2-ethylhexylene, 1,1,3-trimethylhexylene, 1,1,3,3-tetramethylpentylene, nonylene, decylene, undecylene, 1-methylundecylene, dodecylene, 1,1,3,3,5,5-hexamethylhexylene, tridecylene, tetradecylene, pentadecylene, hexadecylene, heptadecylene and octadecylene.

In a preferred embodiment, X₁ is a direct bond oxygen, phenyl, or phenyl substituted by 1, 2 or 3 C₁-C₄alkyl, more preferably X₁ is a direct bond oxygen, or phenyl.

As used herein, the term “direct bond”, where part of a structural variable specification, refers to the direct joining of the substituents flanking (preceding and succeeding) the variable taken as a “direct bond”.

In a more preferred embodiment, the compound of formula (A) is selected from the formulae (A-1), (A-2), (A-3), (A-4), (A-5), (A-6), or (A-7),

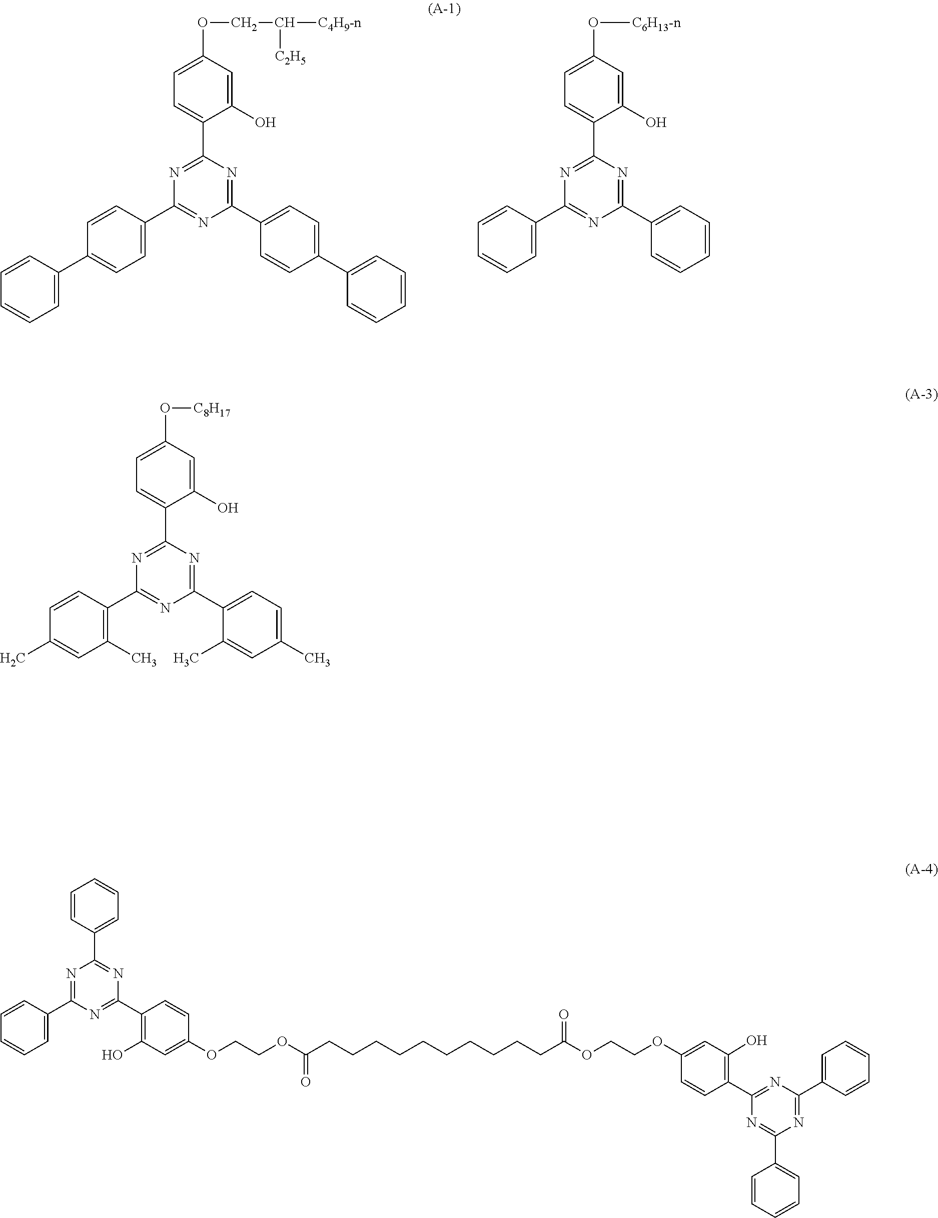

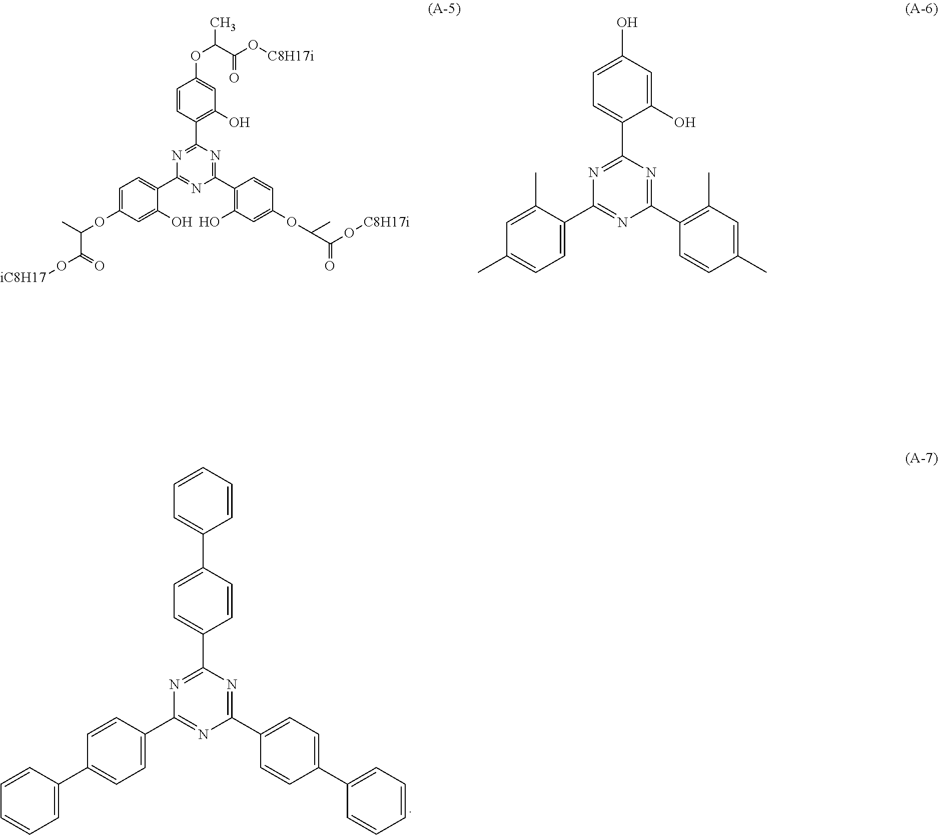

In even a more preferred embodiment, the compound of formula (A) is selected from the formulae (A-1), (A-2), or (A-6). Most of the compounds of the formulae (A) are known and can be prepared in analogy to processes known to those skilled in the art.

The compounds of the formula (A) can be prepared for example in analogy to the methods described in U.S. Pat. No. 6,255,483.

In a preferred embodiment, the total amount of the compound of formula (A) in the composition is in the range of 0.02 to 1 wt % based on the total weight of the composition. In a more preferred embodiment, the total amount of the compound of formula (A) in the composition is in the range of 0.02 to 0.9 wt %, or 0.02 to 0.8 wt %, or 0.02 to 0.7 wt %, or 0.02 to 0.6 wt %, or 0.03 to 0.6 wt %, or 0.04 to 0.6 wt %, based on the total weight of the composition. In a most preferred embodiment, the total amount of the compound of formula (A) in the composition is in the range of 0.05 to 0.6 wt % based on the total weight of the composition. In a preferred embodiment, the UV absorber is selected from 2-(2′-hydroxyphenyl)benzotriazole, 2-hydroxybenzophenone, 2-(2-hydroxyphenyl)-1,3,5-triazine, cyanoacrylate, oxanilide, benzoxazinone, esters of substituted and unsubstituted benzoic acid, or mixtures of two or more thereof.

Preferably, 2-(2′-hydroxyphenyl)benzotriazole is selected from 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy) carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂—, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole, 2-[2′-hydroxy-3′-(1,1,3,3-tetramethylbutyl)-5′-(α,α-dimethylbenzyl)-phenyl]benzotriazole, or mixtures of two or more thereof.

More preferably, 2-(2′-hydroxyphenyl)benzotriazole is selected from 2-(2′-hydroxy-5′-methylphenyl)-benzotriazole, 2,2′-methylene-bis[4-(1,1,3,3-tetramethylbutyl)-6-benzotriazole-2-ylphenol], 2-(3′,5′-bis-(α,α-dimethylbenzyl)-2′-hydroxyphenyl)benzotriazole, 2-(3′-tert-butyl-2′-hydroxy-5′-methylphenyl)-5-chloro-benzotriazole, or mixtures thereof.

Preferably, 2-hydroxybenzophenone is selected from 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, 1,4-bis(4-benzoyl-3-hydroxyphenoxy)-butane, or mixtures of two or more thereof.

Preferably, 2-(2-hydroxyphenyl)-1,3,5-triazine is selected from, other than the compounds of formula A, 2,4,6-tris(2-hydroxy-4-octyloxyphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-[2-Hydroxy-4-[3-(2-ethylhexyl-1-oxy)-2-hydroxypropyloxy]phenyl]-4,6-bis(2,4-dimethylphenyl)-1,3,5-triazine, 5-Butoxy-2-[4-(4-butoxy-2-hydroxyphenyl)-6-(2,4-dibutoxyphenyl)-1,3,5-triazin-2-yl]phenol, 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine, Propanoic acid, 2-(4-(4,6-bis((1,1′-biphenyl)-4-yl)-1,3,5-triazin-2-yl)-3-hydroxyphenoxy)-, isooctyl ester, Bis-Ethylhexyloxyphenol Methoxyphenyl Triazine, or mixtures of two or more thereof.

The cyanoacrylate UV absorber is preferably selected from ethyl α-cyano-β,β-diphenylacrylate, isooctyl α-cyano-β,β-diphenylacrylate, neopentyl tetra(α-cyano-β,β-diphenylacrylate), pentaerythritol tetrakis(2-cyano-3,3-diphenylacrylate), ethyl 2-cyano-3,3-diphenylacrylate, (2-ethylhexyl)-2-cyano-3,3-diphenyl acrylate, or mixtures of two or more thereof. More preferably, the cyanoacrylate UV absorber is pentaerythritol tetrakis(2-cyano-3,3-diphenylacrylate).

The oxanilide is preferably selected from 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl) oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides, mixtures of o- and p-ethoxy-disubstituted oxanilides, or mixtures of two or more thereof. More preferably, the oxanilide is 2-ethoxy-2′-ethyloxanilide.

In a preferred embodiment, the total amount of the UV absorber in the composition is in the range of 0.05 to 10 wt % based on the total weight of the composition.

In a more preferred embodiment, the total amount of the UV absorber in the composition is in the range of 0.05 to 8 wt %, or 0.1 to 8 wt %, or 0.2 to 5 wt %, or 0.3 to 5 wt %, or 0.4 to 4 wt %, or 0.4 to 3 wt %, or 0.4 to 2.5 wt %, based on the total weight of the composition.

In a most preferred embodiment, the total amount of the UV absorber in the composition is in the range of 0.4 to 2.5 wt % based on the total weight of the composition.

In a preferred embodiment, a composition comprising:
i. a polycarbonate in an amount in the range of 90 to 99.9 wt % based on the total weight of the composition;
ii. at least one compound of formula (A) selected from the formulae (A-1), (A-2), (A-3), (A-4), (A-5), (A-6), or (A-7), in an amount in the range of 0.02 to 0.8 wt % based on the total weight of the composition,

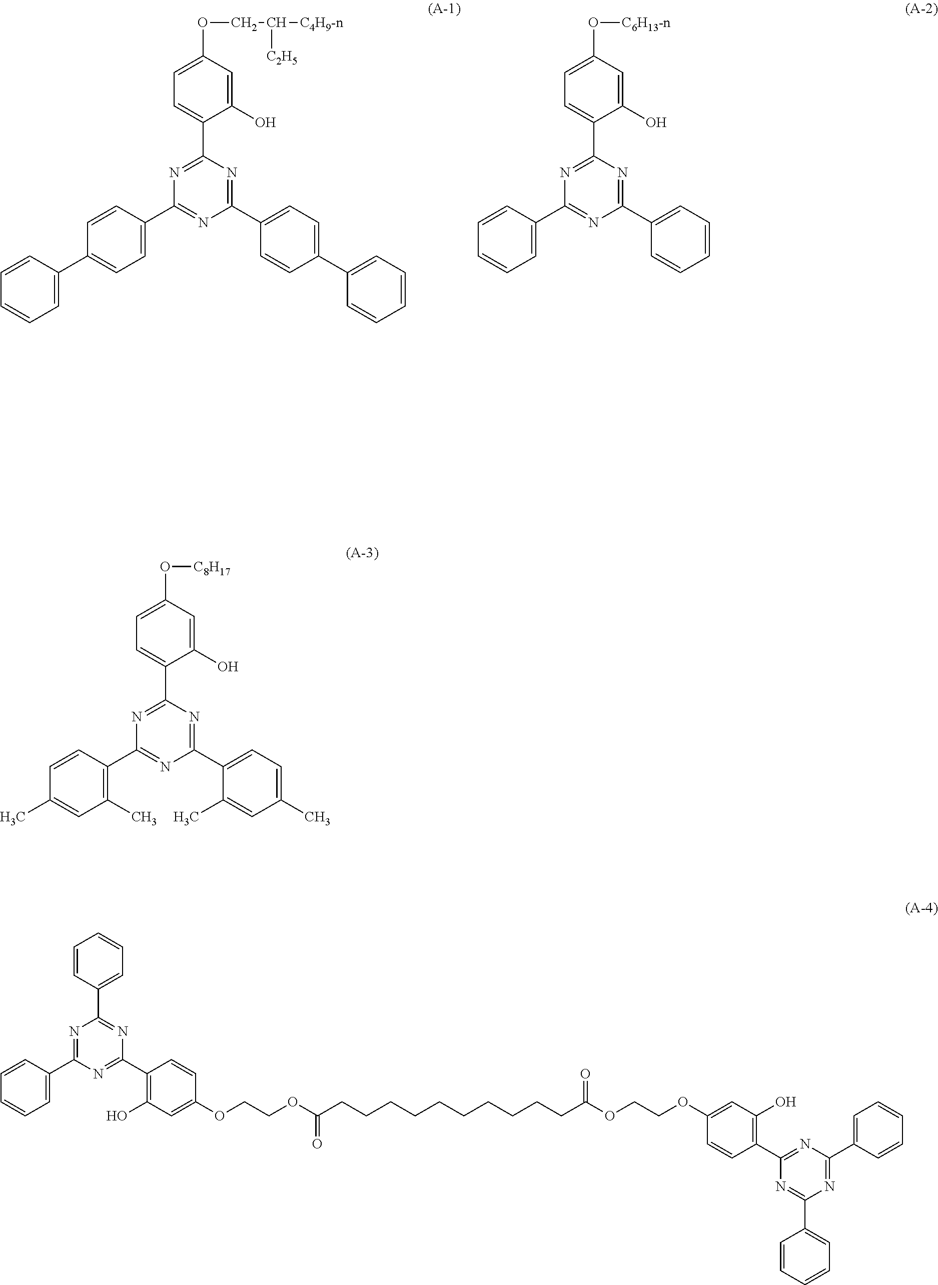

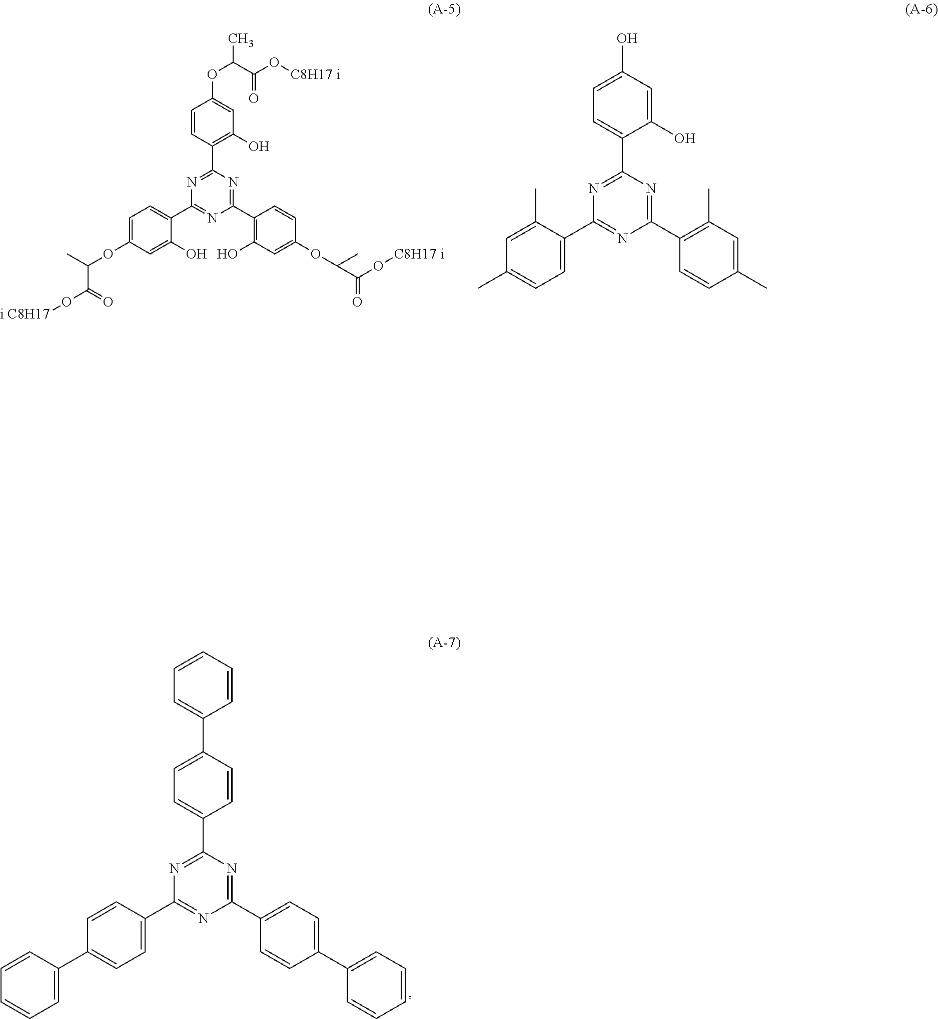

and
iii. at least one UV absorber, other than the compound of formula (A), in an amount in the range of 0.4 to 2.5 wt % based on the total weight of the composition.

In a preferred embodiment, the composition further comprises at least one antioxidant.

The antioxidant is preferably selected from phenolic antioxidant, organophosphorus stabilizer, or mixtures thereof.

More preferably, the phenolic antioxidant is selected from octadecyl-3-(3,5-di-tert-butyl-4-hydroxyphenyl)propionate, 1,3,5-tris(3,5-di-tert-butyl-4-hydroxybenzyl)-2,4,6-trimethylbenzene, N,N′-bis(3,5-di-tert-butyl-4-hydroxyphenylpropionyl)hexamethylene-diamide, 1,3,5-tris[3,5-di-tert-butyl-4-hydroxybenzyl]isocyanurate, 2,4-di-t-butylphenyl-3,5-di-t-butyl-4-hydroxybenzoate, bis(1,2,2,6,6-pentamethylpiperidin-4-yl)-butyl(3,5-di-t-butyl-4-hydroxybenzyl)malonate), blend of octadecyl-3-(3,5-di-tert-butyl-4-hydroxyphenyl)propionate and tris[2,4-di-tert-butylphenyl]phosphite, or mixtures of two or more thereof.

Most preferably, the phenolic antioxidant is selected from octadecyl-3-(3,5-di-tert-butyl-4-hydroxyphenyl)propionate, or blend of octadecyl-3-(3,5-di-tert-butyl-4-hydroxyphenyl)propionate and tris[2,4-di-tert-butylphenyl]phosphite.

The organophosphorus stabilizer is preferably selected from organic phosphite, organic phosphonite, organic phosphine, or mixtures of two or more thereof.

More preferably, the organic phosphite is tris(2,4-di-tert-butylphenyl)phosphite.

More preferably, the organic phosphine is triphenylphosphine.

In a preferred embodiment, the total amount of the antioxidant in the composition is in the range of 0.01 to 2 wt % based on the total weight of the composition.

In a more preferred embodiment, the total amount of the antioxidant in the composition is in the range of 0.05 to 1.5 wt %, or 0.05 to 1 wt %, or 0.05 to 0.5 wt %, based on the total weight of the composition.

In a most preferred embodiment, the total amount of the antioxidant in the composition is in the range of 0.08 to 0.2 wt % based on the total weight of the composition.

In a preferred embodiment, the weight ratio of the compound of formula (A) to the at least one UV absorber, other than the compound of formula (A), is in the range of 1:50 to 50:1.

In a more preferred embodiment, the weight ratio of the compound of formula (A) to the at least one UV absorber, other than the compound of formula (A), is in the range of 1:45 to 45:1.

In even a more preferred embodiment, the weight ratio of the compound of formula (A) to the at least one UV absorber, other than the compound of formula (A), is in the range of 1:40 to 40:1 or 1:35 to 35:1 or 1:30 to 30:1.

In a most preferred embodiment, the weight ratio of the compound of formula (A) to the at least one UV absorber, other than the compound of formula (A), is in the range of 1:25 to 25:1 or 1:23 to 23:1.

In even a most preferred embodiment, the weight ratio of the compound of formula (A) to the at least one UV absorber, other than the compound of formula (A), is 1:3 to 1:23.

In a preferred embodiment, the weight ratio of the at least one antioxidant to the compound of formula (A), without the sterically hindered amine light stabilizer as defined below, is in the range of 1:0.1 to 1:10, more preferably in the range of 1:0.5 to 1:7.5, even more preferably in the range of 1:1.25 to 1:7.5.

In a preferred embodiment, the weight ratio of the at least one antioxidant to the UV absorber, other than the compound of formula (A), without the sterically hindered amine light stabilizer as defined below, is in the range of 1:22 to 1:30, more preferably 1:22.5 to 1:28.5.

In a preferred embodiment, the composition further comprises at least one sterically hindered amine light stabilizer.

In a more preferred embodiment, the sterically hindered amine light stabilizer is selected from carbonic acid bis(1-undecyloxy-2,2,6,6-tetramethyl-4-piperidyl) ester, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, poly(4-hydroxy-2,2,6,6-tetramethyl-1-piperidineethanol-alt-1,4-butanedioic acid), linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-3-n-octyl-7,7,9,9-tetramethyl-1,3,8-di-tert-butylbenzyl)malonate, triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino) ethane, the condensate of 2-chloro-4,6-di-(4-n-butylamino-1,2,2,6,6-pentamethylpiperidyl)-1,3,5-triazine and 1,2-bis(3-aminopropylamino) ethane, 8-acetyl-3-dodecyl-7,7,9,9-tetrame-thyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino) ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl) ethene, N,N′-bis-formyl-N,N′-bis(2,2,6,6-tetramethyl-4-piperidyl)hexa-methylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, N,N′-bis(2,2,6,6-tetramethyl-4-piperidyl)-N, N′-diformylhexamethylenediamine, mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidineethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, 1,6-Hexanediamine, N¹,N⁵-bis(2,2,6,6-thetramethyl-4-piperidinyl)-, polymers with morpholine-2,4,6-trichloro-1,3,5-triazine reaction products, methylated. 1,6-Hexanediamine, N¹,N⁶-bis(2,2,6,6-thetramethyl-4-piperidinyl)-, polymer with 2,4-dichloro-6-(4-morpholinyl)-1,3,5-triazine, mixture of 1,6-Hexanediamine, N¹,N⁵-bis(2,2,6,6-tetramethyl-4-piperidinyl)-, polymers with morpholine-2,4,6-trichloro-1,3,5-triazine reaction products, methylated and 2-(4,6-Bis-(2,4-dimethylphenyl)-1,3,5-triazin-2-yl)-5-(octyloxy)-phenol, mixture of 1,6-Hexanediamine, N¹,N⁶-bis(2,2,6,6-tetramethyl-4-piperidinyl)-, polymer with 2,4-dichloro-6-(4-morpholinyl)-1,3,5-triazine and 2-(4,6-Bis-(2,4-dimethylphenyl)-1,3,5-triazin-2-yl)-5-(octyloxy)-phenol, or mixtures of two or more thereof.

In a most preferred embodiment, the sterically hindered amine light stabilizer is selected from mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidine ethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, bis(2,2,6,6-tetramethyl-4-piperidyl) sebacate, bis(1-octyloxy-2,2,6,6-tetramethylpiperidyl) sebacate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, or mixtures of two or more thereof.

In a preferred embodiment, the total amount of the sterically hindered amine light stabilizer is in the range of 0.01 to 5 wt % based on the total weight of the composition. In a more preferred embodiment, the total amount of the sterically hindered amine light stabilizer is in the range of 0.05 to 1 wt % based on the total weight of the composition. In a more preferred embodiment, the total amount of the sterically hindered amine light stabilizer is in the range of 0.05 to 0.5 wt % based on the total weight of the composition. In a most preferred embodiment, the total amount of the sterically hindered amine light stabilizer is 0.1 wt % based on the total weight of the composition. In an embodiment, the weight ratio of the compound of formula (A) to the sterically hindered amine light stabilizer is in the range of 1:5 to 5:1.

In a preferred embodiment, the weight ratio of the compound of formula (A) to the sterically hindered amine light stabilizer is in the range of 1:4 to 4:1.

In a more preferred embodiment, the weight ratio of the compound of formula (A) to the sterically hindered amine light stabilizer is in the range of 1:3 to 3:1.

In a more preferred embodiment, the weight ratio of the compound of formula (A) to the sterically hindered amine light stabilizer is in the range of 1:2 to 2:1.

In a most preferred embodiment, the weight ratio of the compound of formula (A) to the sterically hindered amine light stabilizer is 1:1.

In an embodiment, the weight ratio of the sterically hindered amine light stabilizer to the UV absorber, other than the compound of formula (A), is in the range of 1:1 to 1:5.

In a preferred embodiment, the weight ratio of the sterically hindered amine light stabilizer to the UV absorber, other than the compound of formula (A), is in the range of 1:2 to 1:5.

In a more preferred embodiment, the weight ratio of the sterically hindered amine light stabilizer to the UV absorber, other than the compound of formula (A), is in the range of 1:3 to 1:5.

In a most preferred embodiment, the weight ratio of the sterically hindered amine light stabilizer to the UV absorber, other than the compound of formula (A), is in the range of 1:4 to 1:5.

In a preferred embodiment, the composition further comprises at least one compound of formula (B) of General Formula (I), general formula (II), general formula (III) or general formula (IV).

### Compound (B) of General Formula (I):

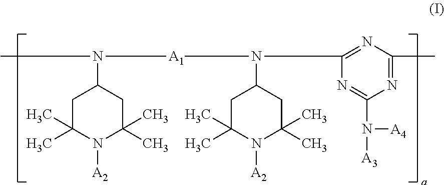

wherein
A₁ is selected from linear or branched, substituted or unsubstituted C₂-C₁₈ alkylene, substituted or unsubstituted C₅-C₇ cycloalkylene and C₁-C₄ alkylenedi (C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

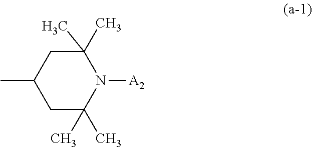

or
A₃ and A₄, together with the nitrogen atom to which they are bonded, form a 5- to 10-membered heterocyclic ring; and
a is an integer in the range of 1 to 20 and the repeating units are the same or different.

Representative examples of linear or branched, unsubstituted C₁-C₁₂ alkyl include, but are not limited to, methyl, ethyl, n-propyl, isopropyl, n-butyl, sec-butyl, isobutyl, tert-butyl, 2-ethylbutyl, n-pentyl, isopentyl, 2-methylbutyl, 3-methylbutyl, 1-methylpentyl, 1,3-dimethylbutyl, n-hexyl, cyclohexyl, 2-methylpentyl, 3-methylpentyl, 4-methylpentyl, 3,3-dimethylbutyl, 1-methylhexyl, n-heptyl, 2-Methylhexyl, 2-Ethylpentyl, isoheptyl, 1,1,3,3-tetramethylbutyl, 1-methylheptyl, 3-methylheptyl, 2-propylheptyl, n-octyl, iso-octyl, 2-ethylhexyl, 1,1,3-trimethylhexyl, 1,1,3,3-tetramethylpentyl, n-nonyl, iso-nonyl, n-decyl, iso-decyl, n-undecyl, iso-undecyl, 1-methylundecyl, n-dodecyl, iso-dodecyl, n-tridecyl, iso-tridecyl, and 1,1,3,3,5,5-hexamethylhexyl.

Representative examples of C₁-C₁₂ alkyloxy include, but are not limited to, methoxy, ethoxy, propoxy, isopropoxy, butoxy, isobutoxy, pentoxy, isopentoxy, hexoxy, heptoxy, octoxy, nonyloxy, decyloxy, undecyloxy, and dodecyloxy.

In a preferred embodiment, alkyloxy is selected from the group consisting of methoxy, ethoxy, propoxy, isopropoxy, butoxy, isobutoxy, pentoxy, isopentoxy, hexoxy, heptoxy, and octoxy. In a more preferred embodiment, alkyloxy is propoxy.

Representative examples of C₅-C₁₂ cycloalkyl are cyclopentyl, cyclohexyl, cycloheptyl, cyclooctyl, cyclononyl, cyclodecyl, cycloundecyl, and cyclododecyl.

Representative examples of C₅-C₁₂cycloalkyloxy are cyclopentoxy, cyclohexoxy, cycloheptoxy, cyclooctoxy, cyclononyloxy, cyclodecyloxy, cycloundecyloxy, and cyclododecyloxy.

In a preferred embodiment the cylcoalkyloxy is cyclohexoxy.

A preferred example of phenyl substituted by 1, 2 or 3 C₁-C₄alkyl is 2,4-dimethylphenyl.

Preferred C₂-C₁₈ alkylenes are ethylene, propylene, trimethylene, tetramethylene, pentamethylene, 2,2-dimethyltrimethylene and hexamethylene. In a more preferred embodiment, alkylene is hexamethylene.

An example of C₅-C₇cycloalkylene is cyclohexylene.

An example of C₁-C₄alkylenedi (C₅-C₇cycloalkylene) is methylenedicyclohexylene.

Examples of the radicals A₃ and A₄ together with the nitrogen atom to which they are bonded, forming a 5- to 10-membered heterocyclic ring, are 1-pyrrolidyl, piperidyl, morpholinyl, 1-piperazinyl, 4-methyl-1-piperazinyl, 1-hexahydroazepinyl, 5,5,7-trimethyl-1-homopiperazinyl or 4,5,5,7-tetramethyl-1-homopiperazinyl, preferably morpholinyl.

In the compound (B) of the general formula (I) the terminal group attached to the diamino residue is for example hydrogen or a group of the formula

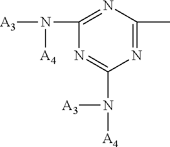

and the terminal group attached to the triazine radical is for example a group of the formula

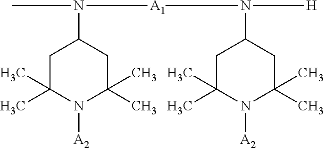

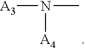

or a group of the formula

In a preferred embodiment, A₁ is hexamethylene, and A₂ is hydrogen, and propoxy.

In a preferred embodiment, A₃ is butyl,

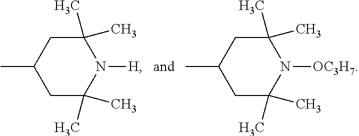

In a preferred embodiment, A₄ is butyl.

In a preferred embodiment, a is an integer in the range of 1 to 10.

### Compound (B) of General Formula (II):

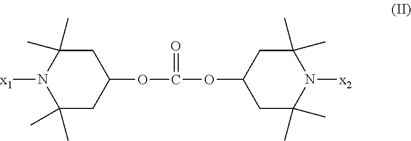

wherein
x₁ and x₂ is independently selected from C₁ to C₃₀ alkoxy,

In a preferred embodiment, X₁ and x₂ are independently selected from linear or branched, unsubstituted C₁ to C₃₀ alkyloxy.

Representative examples of linear or branched, unsubstituted C to C₃₀ alkyloxy are methyloxy, ethyloxy, propyloxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, icosyloxy, henicosyloxy, docosyloxy, tricosyloxy, tetracosyloxy, pentacosyloxy, hexacosyloxy, heptacosyloxy, octacosyloxy, nonacosyloxy and triacontyloxy.

In a preferred embodiment, x₁ and x₂ are each undecyloxy.

### Compound (B) of General Formula (III):

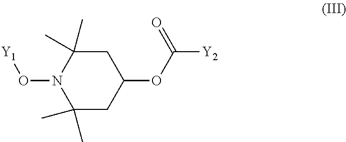

wherein
Y₁ is linear or branched, substituted or unsubstituted C₃ to C₂₀ alkyl,
Y2 is C₁ to C₃₀ alkyl; and

In a preferred embodiment, Y₁ is linear or branched, unsubstituted C₃ to C₂₀ alkyl.

In an embodiment, Y₁ is selected from the group consisting of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and icosyl.

In a preferred embodiment, Y₁ is selected from propyl, or dodecyl.

In a preferred embodiment, Y₂ is linear or branched, unsubstituted C₁ to C₃₀ alkyl.

In an embodiment, Y₂ is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, and triacontyl.

In a preferred embodiment, Y₂ is selected from pentadecyl, or heptadecyl.

### Compound (B) of General Formula (IV):

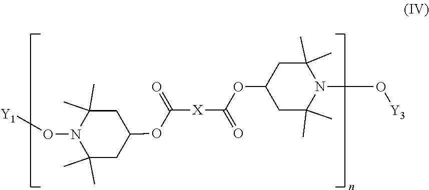

wherein

Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₈ alkyl,
n is an integer in the range of 1 to 8.

In a preferred embodiment, Y₃ is selected from the group consisting of linear or branched, unsubstituted C₃ to C₂₀ alkyl and C₃ to C₂₀ alkylidene.

Representative examples of alkylidene having up to 20 carbon atoms are methylidene, ethylidene, propylidene, butylidene, pentylidene, hexylidene, heptylidene, octylidene, nonylidene, decylidene, undecylidene, dodecylidene, tridecylidene, tetradecylidene, pentadecylidene, hexadecylidene, heptadecylidene, octadecylidene, nonadecylidene, and icosylidene.

In a preferred embodiment, Y₁ is selected from decyl.

In a preferred embodiment, Y₃ is selected from decyl, or nonylidene.

In a preferred embodiment, X is selected from the group consisting of ethyl, propyl, butyl, pentyl, hexyl, heptyl, and octyl.

In a more preferred embodiment, the compound of formula (B) is selected from the formulae (B-1), (B-2), (B-3), (B-4), (B-5), (B-6), (B-7), (B-8), or mixtures of two or more 5 thereof.

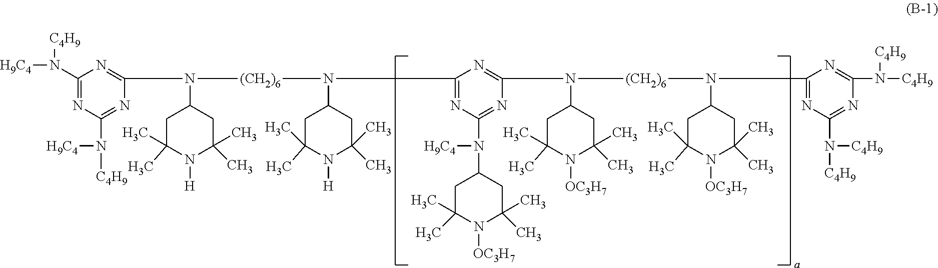

wherein a is an integer in the range of 1 to 10; and

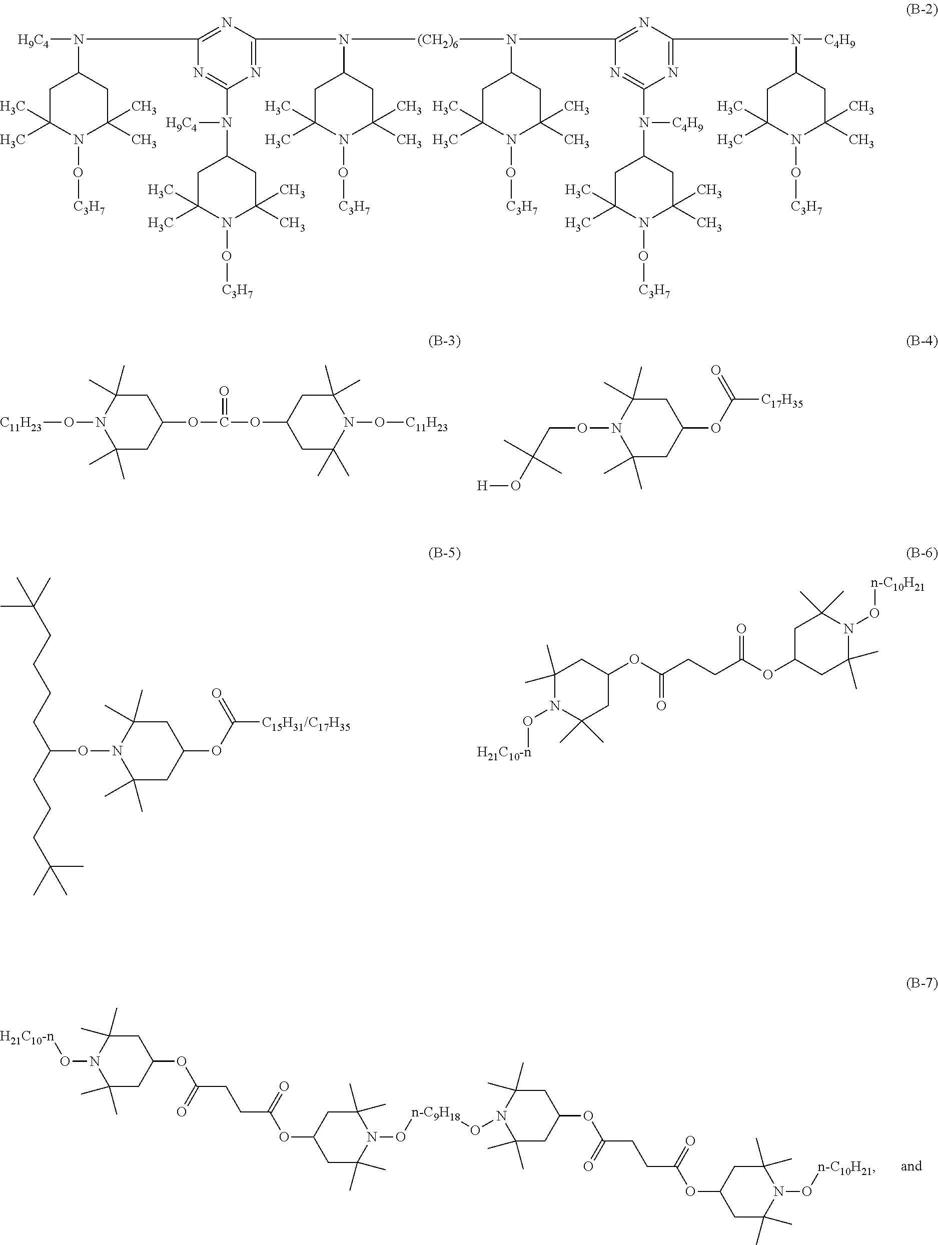

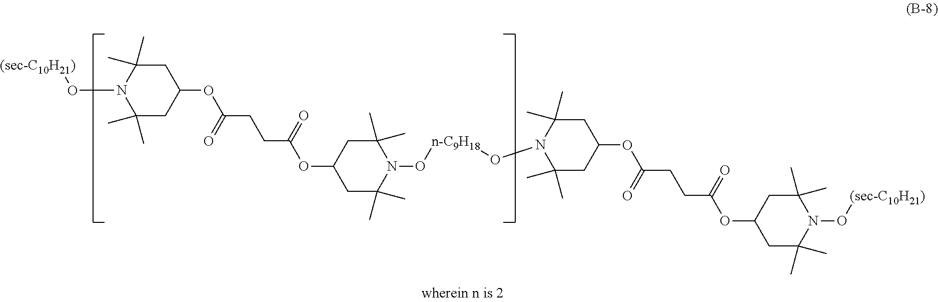

In a preferred embodiment, the composition further comprises at least one additive selected from anti-scratch agents, slip agents, anti-block agents, thermal fillers, pigments, anti-fog, or anti-mist agents.

The composition may additionally also contain various conventional additives, for example:

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl) phenol, 2,4-dimethyl-6-(1′-methylheptadec-1′-yl) phenol, 2,4-dimethyl-6-(1′-methyltridec-1′-yl) phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example a-tocopherol, b-tocopherol, g-tocopherol, d-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(a-methylcyclohexyl) phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(a-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl) propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl) pentane.

1.7. O-, N- and S-benzyl compounds, for example 3,5,3′,5′-tetra-tert-butyl-4,4′-dihydroxydi-benzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl) sulfide, isooctyl-3,5-di-tert-butyl-4-hydroxybenzylmercaptoacetate. 1.8. Hydroxybenzylated malonates, for example dioctadecyl-2,2-bis(3,5-di-tert-butyl-2-hydroxybenzyl) malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,4-bis(3,5-di-tert-butyl-4-hydroxybenzyl)-2,3,5,6-tetramethylbenzene, 2,4,6-tris(3,5-di-tert-butyl-4-hydroxybenzyl) phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bi (3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(4-tert-butyl-3-hydroxy-2,6-dimethylbenzyl) isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl) isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl) carbamate.

1.13. Esters of b-(3,5-di-tert-butyl-4-hydroxyphenyl) propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxamide, 3-thiaundecanol, 3-thiapentadecanol, trimethylhexanediol, trimethylol-propane, 4-hydroxymethyl-1-phospha-2,6,7-trioxabicyclo[2.2.2]octane.

1.14. Esters of b-(5-tert-butyl-4-hydroxy-3-methylphenyl) propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl) oxamide, 3-thiaundecanol, 3-thiapentadecanol, trimethylhexanediol, trimethyl-olpropane, 4-hydroxymethyl-1-phospha-2,6,7-trioxabicyclo[2.2.2]octane; 3,9-bis[2-{3-(3-tert-butyl-4-hydroxy-5-methylphenyl) propionyloxy}-1,1-dimethylethyl]-2,4,8,10-tetraoxaspiro[5.5]undecane.

1.15. Esters of b-(3,5-dicyclohexyl-4-hydroxyphenyl) propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, tri-ethylene glycol, pentaerythritol, tris(hydroxyethyl) isocyanurate, N,N′-bis(hydroxyethyl) oxamide, 3-thiaundecanol, 3-thiapentadecanol, trimethylhexanediol, trimethylolpropane, 4-hy-droxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxamide, 3-thiaundecanol, 3-thiapentadecanol, trimethylhexanediol, trimethylolpropane, 4-hy-droxymethyl-1-phospha-2,6,7-trioxabicyclo[2.2.2]octane.

1.17. Amides of b-(3,5-di-tert-butyl-4-hydroxyphenyl) propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl) hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenylamino) propane, (o-tolyl) biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1. Esters of substituted and unsubstituted benzoic acids, for example 4-tert-butylphenyl salicylate, phenyl salicylate, octylphenyl salicylate, dibenzoyl resorcinol, bis(4-tert-butylben-zoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.2. Acrylates, for example ethyl a-cyano-b,b-diphenylacrylate, isooctyl a-cyano-b,b-diphenylacrylate, methyl a-carbomethoxycinnamate, methyl α-cyano-b-methyl-p-methoxycinnamate, butyl α-cyano-b-methyl-p-methoxy-cinnamate, methyl a-carbomethoxy-p-methoxycinnamate, N-(b-carbomethoxy-b-cyanovinyl)-2-methylindoline, neopentyl tetra(a-cyano-b,b-diphenylacrylate.

2.3. Nickel compounds, for example nickel complexes of 2,2′-thio-bis[4-(1,1,3,3-tetramethyl-butyl) phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphe-nylundecylketoxime, nickel complexes of 1-phenyl-4-lauroyl-5-hydroxypyrazole, with or with-out additional ligands.

2.4. 2-(2-Hydroxyphenyl)-1,3,5-triazines, for example 2,4,6-tris(2-hydroxy-4-octyloxyphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-di-methylphenyl)-1,3,5-triazine, 2,4-bis(4-[2-ethylhexyloxy]-2-hydroxyphenyl)-6-(4-methoxyphenyl)-1,3,5-triazine.

2.5. Benzylidene-bis-malonate: 1,1,3,3′-Tetraethyl-2,2′-(1,4-phenylenedimethylidyne)bis[propanedioate]

3. Metal deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene) oxalyl dihydrazide, oxanilide, isophthaloyl dihydrazide, sebacoyl bisphenylhydrazide, N,N′-diacetyladipoyl dihydrazide, N,N′-bis(salicyloyl) oxalyl dihydrazide, N,N′-bis(salicyloyl)thiopropionyl dihydrazide.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl)phosphite, diisodecyl pentaerythritol diphosphite, bis(2,4-di-tert-butylphenyl) pentaerythritol diphosphite, bis(2,4-di-cumylphenyl) pentaerythritol diphosphite, bis(2,6-di-tert-butyl-4-methylphenyl) pentaerythritol diphosphite, diisodecyloxypentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz [d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz [d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS: 939402-2-5), phosphorous acid, triphenyl ester, polymer with α-hydro-ω-hydroxypoly [oxy(methyl-1,2-ethanediyl)], C10-16-alkyl esters (CAS: 1227937-46-3), Triphenyl phosphite, polymer with 1,4-cyclohexanedimethanol and polypropylene glycol, C10-16 alkyl esters (CAS Reg. No. 1821217-71-3).

The following phosphites are especially preferred:

Tris(2,4-di-tert-butylphenyl)phosphite (Irgafos®168, Ciba Specialty Chemicals Inc.), tris(nonylphenyl) phosphite,

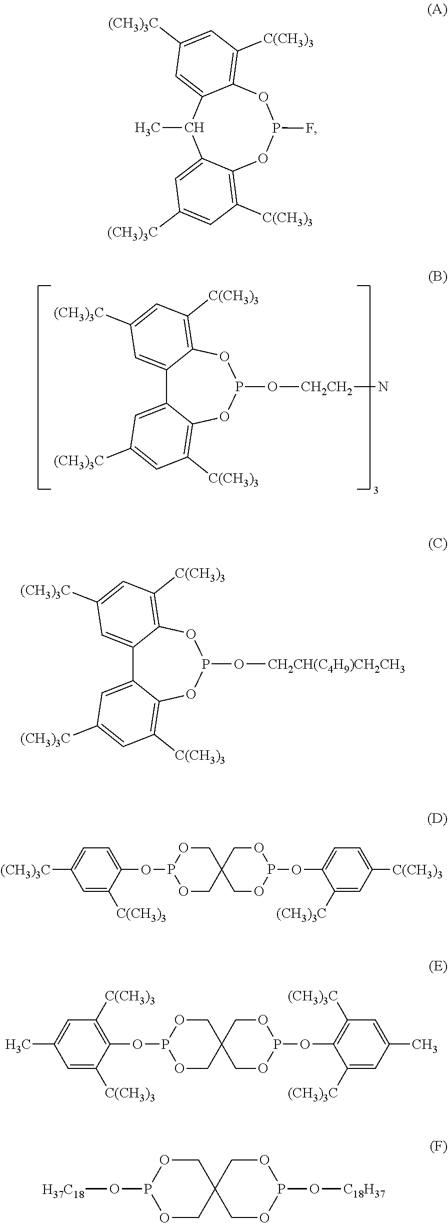

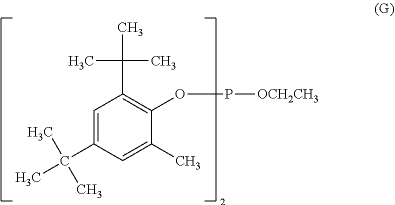

5. Hydroxylamines, for example N, N-dibenzylhydroxylamine, N, N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N, N-dialkylhydroxylamine derived from hydrogenated tallow amine.

6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecyInnitrone, N-hexadecyl-alpha-pentadecylnitrone, N-octadecyl-alpha-N-ocatadecyl-alpha-heptadecylnitrone, N-hexadecyl-alpha-heptadecylnitrone, pentadecylnitrone, N-heptadecyl-alpha-heptadecylnitrone, N-octadecyl-alpha-hexadecylnitrone, nitrone derived from N, N-dialkylhydroxylamine derived from hydrogenated tallow amine.

7. Thiosynergists, for example dilauryl thiodipropionate, dimistryl thiodipropionate, pentaerythritol tetrakis[3-(dodecylthio)propionate], distearyl thiodipropionate or distearyl disulfide.

8. Peroxide scavengers, for example esters of b-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(b-dodecylmercapto) propionate.

9. Polyamide stabilizers, for example copper salts in combination with iodides and/or phos-phorus compounds and salts of divalent manganese.

10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene) sorbitol, 1,3:2,4-di(paramethyl-dibenzylidene) sorbitol, and 1,3:2,4-di(benzylidene) sorbitol.

12. Fillers and reinforcing agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

In another aspect, the presently claimed invention is directed to an additive mixture comprising:
I. at least one compound of formula (A) as defined above; and
II. at least one UV absorber as defined above.

In a preferred embodiment, the additive mixture further comprises at least one antioxidant as defined above; at least one sterically hindered amine light stabilizer as defined above; at least one compound of formula (B) as defined above; and at least one additive selected from anti-scratch agents, slip agents, anti-block agents, thermal fillers, pigments, anti-fog, or anti-mist agents.

In yet another aspect, the presently claimed invention is directed to the use of the additive mixture, as defined above, for enhancing optical properties of the molded or extruded articles, including multi-layered articles.

The multi-layered articles containing at least one layer consisting of a composition according to the invention.

These multi-layered articles are preferably produced by coextrusion. Coextrusion per se is known (cf. e.g., EP-AO 110 221 and EP-AO 110 238).

The articles according to the invention have proved particularly advantageous in the weathering test. They do not exhibit any drawbacks in the articles obtained from the production. The optical properties of the coextruded polycarbonate sheets is distinctly better, even with relatively small concentrations of a UV absorbers, with HPTs of formula (A), than when a standard UV absorber is used.

Thus, another aspect of the present invention is an article comprising the composition as defined above.

In a preferred embodiment, the composition according to the invention is used to produce shaped articles, particularly sheets and articles made therefrom, such as e.g., glazing for greenhouses, conservatories, bus shelters, advertising hoardings, signs, safety screens, car glazing, windows, roofing, solid sheets, corrugated sheets, multi-wall sheets, and multi-wall profiles.

In more detail, the composition according to the present invention may be used for the preparation of the following devices:
I-1) Automotive applications, in particular headlamp glass, head lights, parking lights, rear lights, stop lights, and glass.
III-2) Shutters (e.g. roller shutters).
III-3) Profiles of any geometry (window panes).
III-4) Glass substitutes, in particular extruded plates, glazing for buildings (monolithic, twin or multiwall), aircraft, schools, extruded sheets, window film for architectural glazing, train, transportation, sanitary articles, and greenhouse.

The presently claimed invention offers one or more of the following advantages:
1. The articles prepared by using a combination of at least one compound of formula (A), at least one UV absorber, other than the compound of formula (A), and a polycarbonate improves optical properties of the polycarbonate sheets or polycarbonate articles which are exposed to light.
2. The polycarbonate sheets or polycarbonate articles with improved optical properties with respect to light exposure, prolongs the lifetime of the polycarbonate sheets or polycarbonate articles.
3. The long-lasting effect of the polycarbonate sheets or polycarbonate articles results in economic value.

In the following, specific embodiments of the presently claimed invention are described:
1. A composition comprising:
   i. a polycarbonate in an amount in the range of 90 to 99.9 wt % based on the total weight of the composition;
   ii. at least one compound of formula (A) selected from the formulae (A-1), (A-2), (A-3), (A-4), (A-5), (A-6), or (A-7) in an amount in the range of 0.02 to 0.8 wt % based on the total weight of the composition,

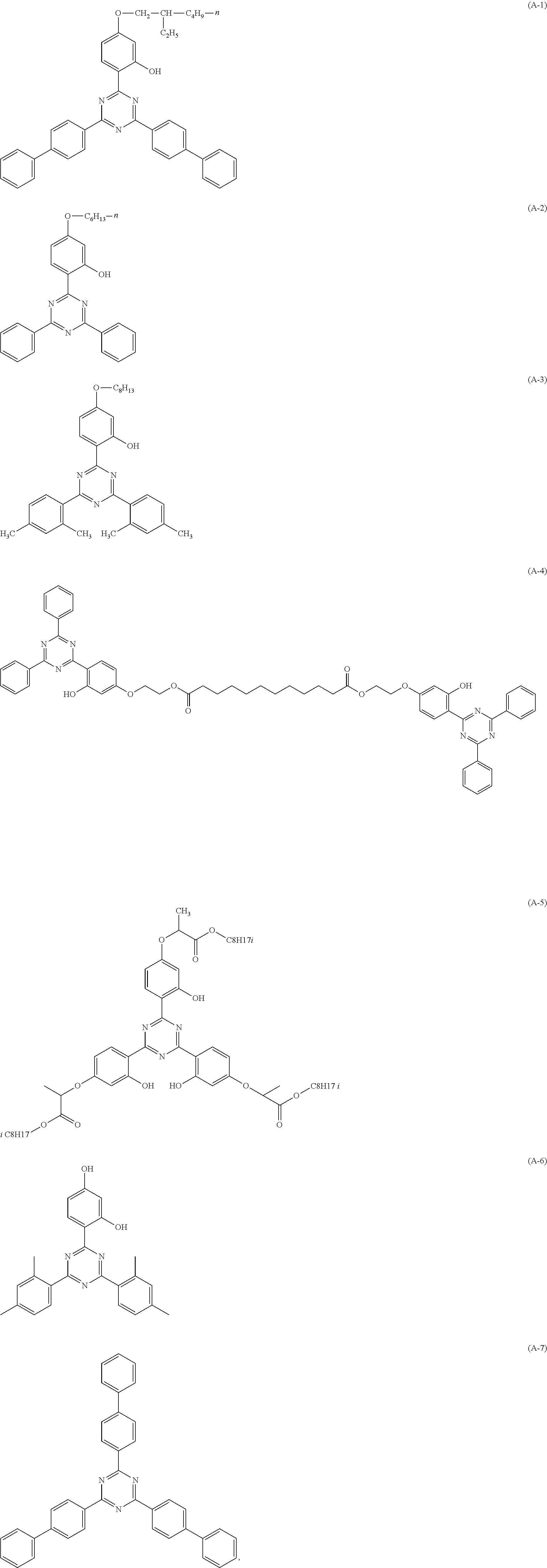

and
iii. at least one UV absorber, other than the compound of formula (A), in an amount in the range of 0.4 to 2.5 wt % based on the total weight of the composition.
2. The composition according to embodiment 1, wherein the polycarbonate is selected from homopolycarbonates, copolycarbonates, thermoplastic polyester carbonates, polycarbonate/acrylonitrile-butadiene-styrene terpolymer blend, thermoplastic alloy of polycarbonate/acrylic-styrene-acrylonitrile terpolymer, thermoplastic alloy blend of polycarbonate/polybutylene terephthalate, thermoplastic alloy of polycarbonate/polyethylene terephthalate, or thermoplastic alloy of polycarbonate and styrene-acrylonitrile.
3. The composition according to embodiment 1, wherein the UV absorber is selected from 2-(2′-hydroxyphenyl)benzotriazole, 2-hydroxybenzophenone, 2-(2-hydroxyphenyl)-1,3,5-triazine, cyanoacrylate, oxanilide, benzoxazinone, esters of substituted and unsubstituted benzoic acid, or mixtures of two or more thereof.
4. The composition according to embodiment 3, wherein 2-(2′-hydroxyphenyl)benzotriazole is selected from 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphe-nyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy) carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂, where R=3′-tert-butyl-4′-2 hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole, 2-[2′-hydroxy-3′-(1,1,3,3-tetramethylbutyl)-5′-(α,α-dimethylbenzyl)-phenyl]benzotriazole, or mixtures of two or more thereof.
5. The composition according to embodiment 3 or embodiment 4, wherein 2-(2′-hydroxyphenyl)benzotriazole is selected from 2-(2′-hydroxy-5′-methylphenyl)-benzo-triazole, 2,2′-methylene-bis[4-(1,1,3,3-tetramethylbutyl)-6-benzotriazole-2-ylphenol], 2-(3′,5′-bis-(α,α-dimethylbenzyl)-2′-hydroxyphenyl)benzotriazole, 2-(3′-tert-butyl-2′-hydroxy-5′-methylphenyl)-5-chloro-benzotriazole, or mixtures thereof.
6. The composition according to embodiment 3, wherein 2-hydroxybenzophenone is selected from 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, 1,4-bis(4-benzoyl-3-hydroxyphenoxy)-butane, or mixtures of two or more thereof.
7. The composition according to embodiment 3, wherein 2-(2-hydroxyphenyl)-1,3,5-triazine is selected from, other than the compounds of formula A, 2,4,6-tris(2-hydroxy-4-octyloxyphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-[2-Hydroxy-4-[3-(2-ethylhexyl-1-oxy)-2-hydroxypropyloxy]phenyl]-4,6-bis(2,4-dimethylphenyl)-1,3,5-triazine, 5-Butoxy-2-[4-(4-butoxy-2-hydroxyphenyl)-6-(2,4-dibutoxyphenyl)-1,3,5-triazin-2-yl]phenol, 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine, Propanoic acid, 2-(4-(4,6-bis((1,1′-biphenyl)-4-yl)-1,3,5-triazin-2-yl)-3-hydroxyphenoxy)-, isooctyl ester, Bis-Ethylhexyloxyphenol Methoxyphenyl Triazine, or mixtures of two or more thereof.
8. The composition according to embodiment 3, wherein the cyanoacrylate UV absorber is selected from ethyl α-cyano-β,β-diphenylacrylate, isooctyl α-cyano-β,β-diphenylacrylate, neopentyl tetra(α-cyano-β,β-diphenylacrylate), pentaerythritol tetrakis(2-cyano-3,3-diphenylacrylate), ethyl 2-cyano-3,3-diphenylacrylate, (2-ethylhexyl)-2-cyano-3,3-diphenyl acrylate, or mixtures of two or more thereof.
9. The composition according to embodiment 3 or embodiment 8, wherein the cyanoacrylate UV absorber is pentaerythritol tetrakis(2-cyano-3,3-diphenylacrylate).
10. The composition according to embodiment 3, wherein the oxanilide is selected from 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl) oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides, mixtures of o- and p-ethoxy-disubstituted oxanilides, or mixtures of two or more thereof.
11. The composition according to one or more of embodiments 1 to 10, wherein the composition further comprises at least one antioxidant.
12. The composition according to embodiment 11, wherein the antioxidant is selected from phenolic antioxidant, organophosphorus stabilizer, or mixtures thereof.
13. The composition according to embodiment 11 or embodiment 12, wherein the phenolic antioxidant is selected from octadecyl-3-(3,5-di-tert-butyl-4-hydroxyphenyl)propionate, 1,3,5-tris(3,5-di-tert-butyl-4-hydroxybenzyl)-2,4,6-trimethylbenzene, N,N′-bis(3,5-di-tert-butyl-4-hydroxyphenylpropionyl)hexamethylene-diamide, 1,3,5-tris[3,5-di-tert-butyl-4-hydroxybenzyl]isocyanurate, 2,4-di-t-butylphenyl-3,5-di-t-butyl-4-hydroxybenzoate, bis(1,2,2,6,6-pentamethylpiperidin-4-yl)-butyl(3,5-di-t-butyl-4-hydroxybenzyl)malonate), blend of octadecyl-3-(3,5-di-tert-butyl-4-hydroxyphenyl)propionate and tris[2,4-di-tert-butylphenyl]phosphite, or mixtures of two or more thereof.
14. The composition according to one or more of embodiments 11 to 13, wherein the phenolic antioxidant is selected from octadecyl-3-(3,5-di-tert-butyl-4-hydroxyphenyl)propionate, or blend of octadecyl-3-(3,5-di-tert-butyl-4-hydroxyphenyl)propionate and tris[2,4-di-tert-butylphenyl]phosphite.
15. The composition according to embodiment 12, wherein the organophosphorus stabilizer is selected from organic phosphite, organic phosphonite, organic phosphine, or mixtures of two or more thereof.
16. The composition according to embodiment 15, wherein the organic phosphite is tris(2,4-di-tert-butylphenyl)phosphite.
17. The composition according to embodiment 15, wherein the organic phosphine is triphenylphosphine.
18. The composition according to one or more of embodiments 1 to 17, wherein the weight ratio of the compound of formula (A) to the at least one UV absorber, other than the compound of formula (A), is in the range of 1:50 to 50:1.
19. The composition according to one or more of embodiments 1 to 18, wherein the composition further comprises at least one sterically hindered amine light stabilizer.
20. The composition according to embodiment 19, wherein the sterically hindered amine light stabilizer is selected from carbonic acid bis(1-undecyloxy-2,2,6,6-tetramethyl-4-bis(2,2,6,6-tetramethyl-4-piperidyl) sebacate, bis(2,2,6,6-piperidyl) ester, tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, poly(4-hydroxy-2,2,6,6-tetramethyl-1-piperidineethanol-alt-1,4-butanedioic acid), linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl) malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino) ethane, the condensate of 2-chloro-4,6-di-(4-n-butylamino-1,2,2,6,6-pentamethylpiperidyl)-1,3,5-triazine and 1,2-bis(3-aminopropylamino) ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino) ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl) ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, N,N′-bis(2,2,6,6-tetramethyl-4-piperidyl)-N,N′-diformylhexamethylenediamine, mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidineethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, 1,6-Hexanediamine, N¹,N⁶-bis(2,2,6,6-tetramethyl-4-piperidinyl)-, polymers with morpholine-2,4,6-trichloro-1,3,5-triazine reaction products, methylated, 1,6-Hexanediamine, N¹,N⁶-bis(2,2,6,6-tetramethyl-4-piperidinyl)-, polymer with 2,4-dichloro-6-(4-morpholinyl)-1,3,5-triazine, mixture of 1,6-Hexanediamine, N₁,N₆-bis(2,2,6,6-tetramethyl-4-piperidinyl)-, polymers with morpholine-2,4,6-trichloro-1,3,5-triazine reaction products, methylated and 2-(4,6-Bis-(2,4-dimethylphenyl)-1,3,5-triazin-2-yl)-5-(octyloxy)-phenol, mixture of 1,6-Hexanediamine, N¹,N⁶-bis(2,2,6,6-tetramethyl-4-piperidinyl)-, polymer with 2,4-dichloro-6-(4-morpholinyl)-1,3,5-triazine and 2-(4,6-Bis-(2,4-dimethylphenyl)-1,3,5-triazin-2-yl)-5-(octyloxy)-phenol, or mixtures of two or more thereof.
21. The composition according to embodiments 1, 19 or 20, wherein the sterically hindered amine light stabilizer is selected from mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidine ethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, bis(2,2,6,6-tetramethyl-4-piperidyl) sebacate, bis(1-octyloxy-2,2,6,6-tetramethylpiperidyl) sebacate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, or mixtures of two or more thereof.
22. The composition according to one or more of embodiments 1 to 21, wherein the composition further comprises at least one compound of formula (B) of general formula (I), general formula (II), general formula (III) or general formula (IV)
   compound (B) of General Formula (I)

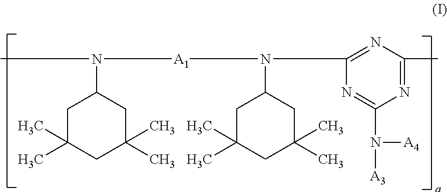

wherein
A₁ is independently selected from linear or branched, substituted or unsubstituted C₂-C₁₈ alkylene, substituted or unsubstituted C₅-C₇ cycloalkylene and C₁-C₄ alkylenedi (C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1),

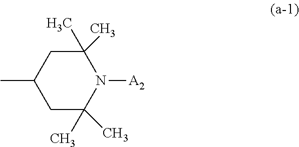

or
A₃ and A₄, together with the nitrogen atom to which they are bonded, form a 5- to 10-membered heterocyclic ring; and
a is an integer in the range of 1 to 20 and the repeating units are the same or different;
compound (B) of General Formula (II)

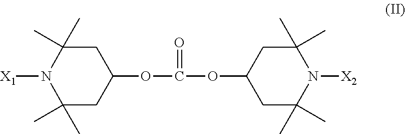

wherein
x₁ and x₂ is independently selected from C₁ to C₃₀ alkoxy,
compound (B) of General Formula (III)

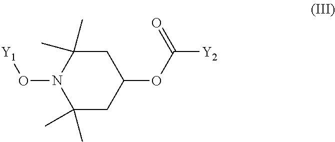

wherein
   Y₁ is linear or branched, substituted or unsubstituted C₃ to C₂₀ alkyl,
   Y₂ is C₁ to C₃₀ alkyl; and
   compound (B) of General Formula (IV)

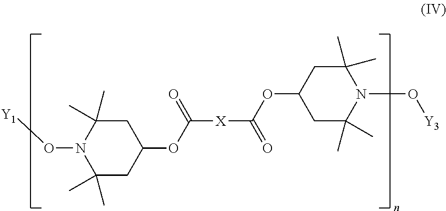

wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₈ alkyl,
n is an integer in the range of 1 to 8.
23. The composition according to embodiment 22, wherein the compound of formula (B) is selected from the formulae (B-1), (B-2), (B-3), (B-4), (B-5), (B-6), (B-7), (B-8), or mixtures of two or more thereof.

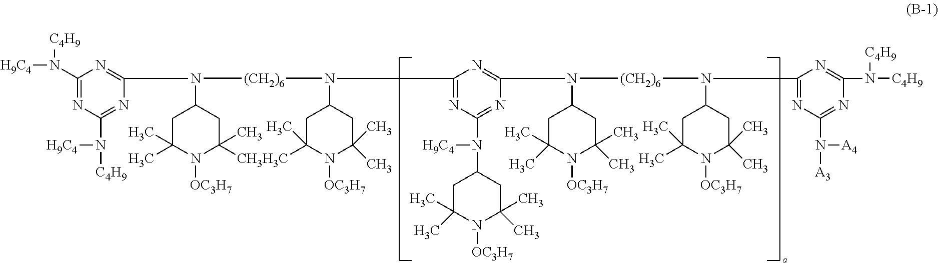

wherein a is an integer in the range of 1 to 10; and

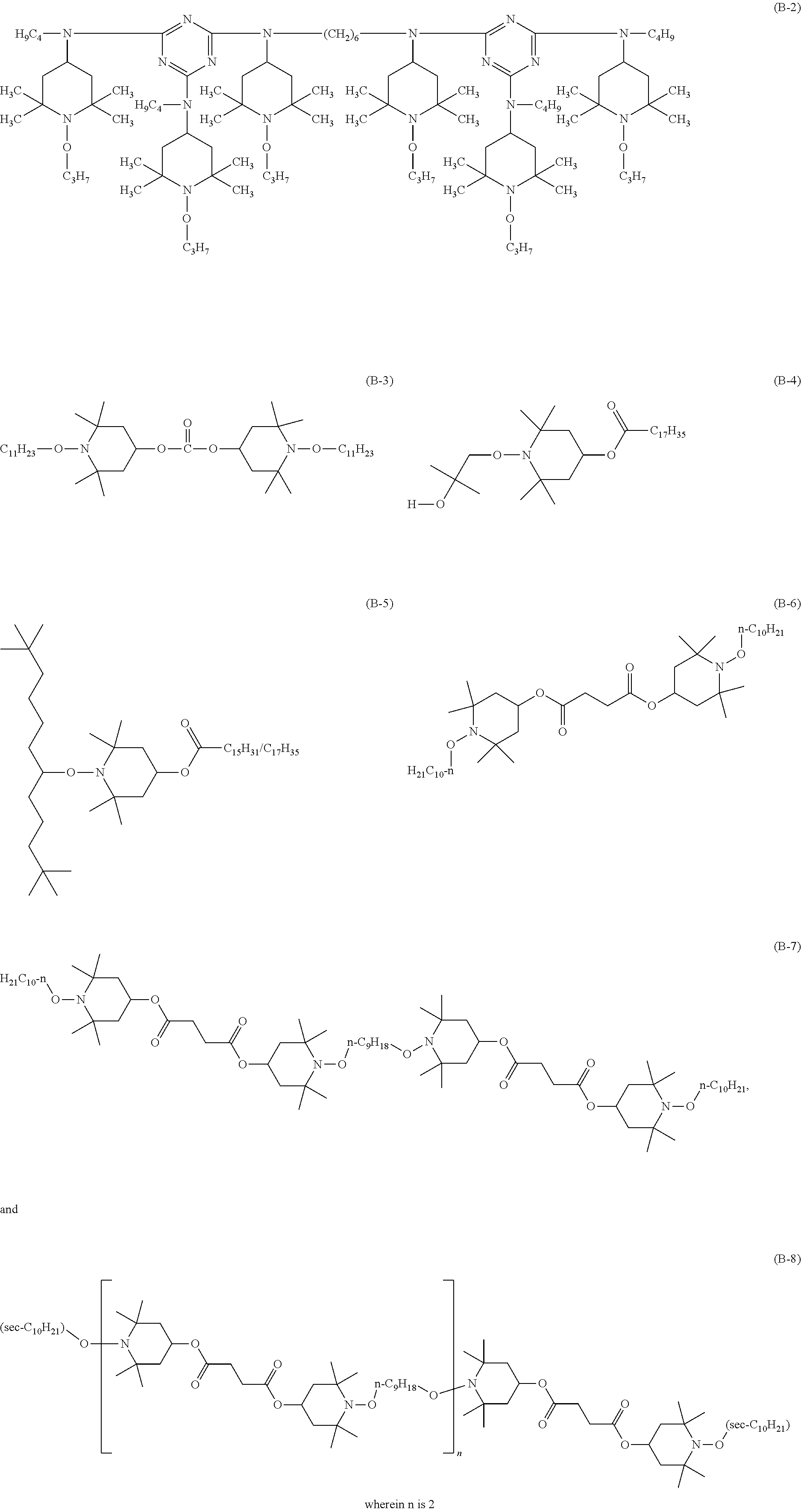

24. The composition according to one or more of embodiments 1 to 23, wherein the composition further comprises at least one additive selected from anti-scratch agents, slip agents, anti-block agents, thermal fillers, pigments, anti-fog, or anti-mist agents.
25. An additive mixture comprising:
   I. at least one compound of formula (A) as defined in embodiment 1; and
   II. at least one UV absorber as defined in any of the embodiments 3 to 10.
26. The additive mixture according to embodiment 25, wherein the additive mixture further comprises at least one antioxidant as defined in any of the embodiments 11 to 17; at least one sterically hindered amine light stabilizer as defined in any of the embodiments 19 or 21; at least one compound of formula (B) as defined in any of the embodiments 22 or 23; and at least one additive selected from anti-scratch agents, slip agents, anti-block agents, thermal fillers, pigments, anti-fog, or anti-mist agents.
27. An article comprising the composition according to one or more of embodiments 1 to 24.
28. Use of the additive mixture according to embodiments 25 or 26 for enhancing optical properties of the molded or extruded articles, including multi-layered articles.

The following examples illustrate the invention in greater detail. All percentages and parts are by weight, unless stated otherwise.

### EXAMPLES

The compounds of the UV absorber packages of tables 1 to 3 are listed below: Compounds of formula (A):

### Compound (A-1):

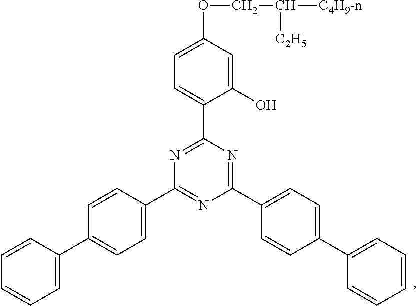

### Compound (A-2):

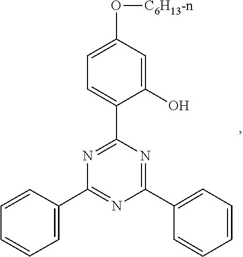

### Compound (A-6):

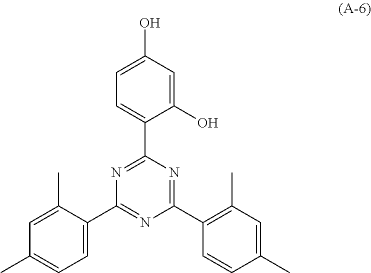

### Antioxidants:

10 Compound (C-1): tris(2,4-di-tert-butylphenyl)phosphite Compound (C-2): blend of octadecyl-3-(3,5-di-tert-butyl-4-hydroxyphenyl)propionate and tris[2,4-di-tert-butylphenyl]phosphite

### UV Absorbers:

Compound (D-1): 2,2′-methylene-bis[4-(1,1,3,3-tetramethylbutyl)-6-benzotriazole-2-ylphenol]
Compound (D-2): pentaerythritol tetrakis(2-cyano-3,3-diphenylacrylate)
Compound (D-3): 2-(3′,5′-bis-(a, a-dimethylbenzyl)-2′-hydroxyphenyl)benzotriazole
Compound (D-4): 2-ethoxy-2′-ethyloxanilide
Compound (D-5): 2-(2′-hydroxy-5′-methylphenyl)-benzotriazole

### Hindered Amine Light Stabilizers:

Compound (E-1): mixture of bis(1,2,2,6,6-pentamethyl-4-piperidyl) sebacate and 1-(methyl)-8-(1,2,2,6,6-pentamethyl-4-piperidyl) sebacate
Compound (E-2): mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidine ethanol-alt-1,4-butanedioic acid)
Compound (E-3): Bis(1,2,2,6,6-pentamethyl-4-piperidinyl)-2-butyl-2-(4-hydroxy-3,5-di-tert.butylbenzyl) propanedioate
Compound (E-4): mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane

### Example 1: Preparation of the Compositions for Table 1

The preparation of a composition containing under vacuum dried (120° C., 4 hours) grinded polycarbonate Makrolon 3108 FBL process stabilized with 0.08% (C-1) and light stabilized with different UV Absorbers packages added by 2.4 wt. % as describe in below table 1.

The mixing was carried out by means of conventional incorporation, by mixing a Vacuum dried (120° C., 4 hours) grinded Makrolon 3108 FBL (120° C., 4 hours) and (C-1) and UV Absorbers using a High speed Mixaco device.

The substance mixtures were then preferably homogenized by a two times single extrusion on a Collin Z K 25E*42D run at 280° C. under Nitrogen. The extrudate was then dried under vacuum at 120° C. for 4 hours before producing a 50 microns polycarbonate sheet.

### Production of Polycarbonate Sheets:

Coextruded solid polycarbonate sheets were produced, for example, by means of a Collin E₃₀M.

### Weathering:

Samples were exposed to artificial weathering according to ASTM G-155 Cyclus 1 (Xenon light with Boro S/Boro S filters, 0.35 W/m2 @ 340 nm, BPT 63+3° C., 50+/−5% Rel. Humidity, Dry Bulk Temperature 42+/−4° C.) using an Atlas CI5000.

### Optical Measurements:

The color changes (YI, Delta E, Haze, Clarity) has been measured over exposure to ASTM G-155 Cyclus 1 (Xenon light with Boro S/Boro S filters, 0.35 W/m2 @ 340 nm, BPT 63+3° C., 50+/−5% Rel. Humidity, Dry Bulk Temperature 42+/−4° C.) using an Atlas CI5000.

TABLE 1
Additive mixtures used in example 1 and results
of these compositions are given in the table 1

| Formulations | | | | |
|---|---|---|---|---|
| Makrolon 3108 FBL grinded + | | | | |
| 0.08% (C-1) + | | | | |
| below UV absorbers | Delta E | YI | Haze (%) | Clarity (%) |
| Control 1: | 5.0 | 8.4 | 5.4 | 97.6 |
| 2.4% (D-1) | | | | |
| Formulation 1 | 4.3 | 7.2 | 2.7 | 98.7 |
| 2.1% (D-1) | | | | |
| 0.3% (A-1) | | | | |
| Formulation 2 | 4.3 | 7.1 | 2.2 | 99.1 |
| 1.8% (D-1) | | | | |
| 0.6% (A-2) | | | | |
| Formulation 3 | 4.6 | 7.6 | 3.4 | 98.5 |
| 2.2% (D-1) | | | | |
| 0.2% (A-1) | | | | |
| Formulation 4 | 4.5 | 7.6 | 3.5 | 98.9 |
| 2.0% (D-1) | | | | |
| 0.4% (A-2) | | | | |
| Formulation 5 | 4.7 | 7.8 | 2.9 | 99.1 |
| 2.1% (D-1) | | | | |
| 0.3% (A-2) | | | | |
| Formulation 6 | 4.6 | 7.8 | 3.9 | 98.6 |
| 2.3% (D-1) | | | | |
| 0.1% (A-1) | | | | |
| Formulation 7 | 4.7 | 7.8 | 3.2 | 98.8 |
| 2.2% (D-1) | | | | |
| 0.2% (A-2) | | | | |
| Control 2: | 5.5 | 8.8 | 6.4 | 96.8 |
| 2.4% (D-2) | | | | |
| Formulation 8 | 5.3 | 8.8 | 3.2 | 98.2 |
| 1.8% (D-2) | | | | |
| 0.6% (A-6) | | | | |
| Formulation 9 | 4.9 | 7.8 | 5.4 | 98.6 |
| 2.2% (D-2) | | | | |
| 0.2% (A-1) | | | | |
| Formulation 10 | 4.8 | 7.7 | 4.1 | 97.1 |
| 2.0% (D-2) | | | | |
| 0.4% (A-2) | | | | |
| Formulation 11 | 5.1 | 8.0 | 4.1 | 98.6 |
| 2.25% (D-2) | | | | |
| 0.15% (A-1) | | | | |
| Formulation 12 | 5.1 | 8.1 | 4.6 | 98.4 |
| 2.1% (D-2) | | | | |
| 0.3% (A-2) | | | | |
| Formulation 13 | 5.2 | 8.2 | 4.9 | 97.8 |
| 2.3% (D-2) | | | | |
| 0.1% (A-1) | | | | |

Polycarbonate sheets/samples have been exposed for 6511 hours to ASTM G-155 Cyclus 1 (Xenon light with Boro S/Boro S filters, 0.35 W/m2 @ 340 nm, BPT 63 ± 3° C., 50 +/− 5% Rel. Humidity, Dry Bulk Temperature 42 +/− 4° C.) using an Atlas CI5000.
As lower the Delta E, YI and % Haze and as higher the % Clarity values as better the tested PC sample

From table 1, it is evident that the results of Delta E, YI, Haze, and Clarity of formulations 1 to 7, and of formulation 8 to 13 are better compared to the control samples 1 and 2, respectively.

### Example 2: Preparation of the Compositions for Table 2

The preparation of a composition containing under vacuum dried (110° C., 3 hours) grinded PC/ABS Alloy Bayblend T 65 XF process stabilized with 0.2% (C-2) and Light stabilized with different UV Absorbers packages added by 0.6 wt. % as describe in below table 2.

The mixing was carried out by means of conventional incorporation, by mixing a Vacuum dried (110° C., 3 hours) grinded PC/ABS Alloy Bayblend T 65 XF and (C-2) and UV Absorbers using a High speed Mixaco device.

The substance mixtures were then preferably homogenized by a double screw extrusion on a Collin 25*42D run at 240° C. under Nitrogen. The extrudate was then dried under vacuum at 110° C. for 3 hours before producing the injection molded plaques (60 mm×60 mm×2 mm) on an Arburg Injection Molding device at 240° C.

### Weathering:

The injection molded plaques (60 mm×60 mm×2 mm) were exposed to artificial weathering according to the international norm DIN EN ISO 4892-2 Cyclus 1 (Xenon light with Boro S/Boro S filters, 1.20 W/m2 @ 420 nm, BPT 65+2° C., 50+/−10% Rel. Humidity, Dry Bulk Temperature 38+/−3° C.) using an Atlas CI65 and DIN ISO 105 B06 Xenon light with Boro S/Soda Lime filters, 60 W/m2 @ 300-400 nm (equivalent to 0.46 W/(m2·nm) @ 340 nm), BPT 100+3° C., 30+/−5% Rel. Humidity, Dry Bulk Temperature 65+/−5° C.) using an Atlas CI5000 have been used.

### Optical Measurements:

The Delta of the color changes between the control 3 and the formulation X—X were measured (Delta YI, Delta DE) has been measured over exposure to DIN EN ISO 4892-2 Cyclus 1 (Xenon light with Boro S/Boro S filters, 1.20 W/m2 @ 420 nm, BPT 65+2° C., 50+/−10% Rel. Humidity, Dry Bulk Temperature 38+/−3° C.) using an Atlas CI65 and DIN ISO 105 B06 Xenon light with Boro S/Soda Lime filters, 60 W/m2 @ 300-400 nm (equivalent to 0.46 W/(m2·nm) @ 340 nm), BPT 100+3° C., 30+/−5% Rel. Humidity, Dry Bulk Temperature 65+/−5° C.) using an Atlas CI500 have been used.

TABLE 2
Additive mixtures used in example 2 and results
of these compositions are given in the table 2

| | Bayblend T65 XF + | | |
|---|---|---|---|
| | 0.2% (C-2) + | | |
| | 0.1 HALS | Delta ΔE | Delta YI |
| Control 3 | / | 0 | 0 |
| 0.6% (D-3) | | | |
| Formulation 14 | / | 1.0 | 1.9 |
| 0.5% (D-3) | | | |
| 0.1% (A-2) | | | |
| Control 4 | (E-1) | 0 | 0 |
| 0.5% (D-4) | | | |
| Formulation 15 | (E-1) | 3.0 | 4.4 |
| 0.4% (D-4) | | | |
| 0.1% (A-2) | | | |
| Control 5 | (E-2) | 0 | 0 |
| 0.5% (D-4) | | | |
| Formulation 16 | (E-2) | 4.6 | 7.0 |
| 0.4% (D-4) | | | |
| 0.1% (A-2) | | | |
| Control 6 | (E-3) | 0 | 0 |
| 0.5% (D-4) | | | |
| Formulation 17 | (E-3) | 3.8 | 5.2 |
| 0.4% (D-4) | | | |
| 0.1% (A-2) | | | |

All samples have been exposed to DIN EN ISO 4892-2 Cyclus 1 (Xenon light with Boro S/Boro S filters, 1.20 W/m2 @ 420 nm, BPT 65 ± 2° C., 50 +/− 10% Rel. Humidity, Dry Bulk Temperature 38 +/− 3° C.) using an Atlas CI65.
As higher the Delta DE (after 1250 hours) and Delta YI (after 1250 hours) between Control 3 to 6 and respective formulation 14 to 17, as better the UV stabilization package.

From table 2, it is evident that the results of Delta ΔE, and YI for formulations 14 to 17 are better compared to the control samples 3 to 6, respectively.

### Example 3: Preparation of the Compositions for Table 3

The composition of table 3 is prepared using the same method as given in example 2 of the present invention.

TABLE 3
Additive mixtures used in example 3 and results
of these compositions are given in the table 3

| | Bayblend T65 XF + | | |
|---|---|---|---|
| | 0.2% (C-2) + | | |
| | 0.1 HALS | Delta ΔE | Delta YI |
| Control 7 | (E-4) | 0 | 0 |
| 0.5% (D-5) | | | |
| Formulation 18 | (E-4) | 1.2 | 2.0 |
| 0.4% (D-5) | | | |
| 0.1% (A-2) | | | |

All samples have been exposed to and DIN ISO 105 B06 Xenon light with Boro S/Soda Lime filters, 60 W/m2 @ 300-400 nm (equivalent to 0.46 W/(m2 · nm) @ 340 nm), BPT 100 ± 3° C., 30 +/− 5% Rel.
Humidity, Dry Bulk Temperature 65 +/− 5° C.,) using an Atlas CI5000.
As higher the Delta DE (after 1000 hours) and Delta YI (after 1250 hours) between Control 7 and respective Formulation 18, as better the UV stabilization package

From table 3, it is evident that the results of Delta ΔE, and YI for formulation 18 is better compared to the control sample 7.

1. A composition comprising:
i. a polycarbonate in an amount in the range of 90 to 99.9 wt % based on the total weight of the composition;
ii. at least one compound of formula (A) selected from the formulae (A-1), (A-2), (A-3), (A-4), (A-5), (A-6), or (A-7) in an amount in the range of 0.02 to 0.8 wt % based on the total weight of the composition, 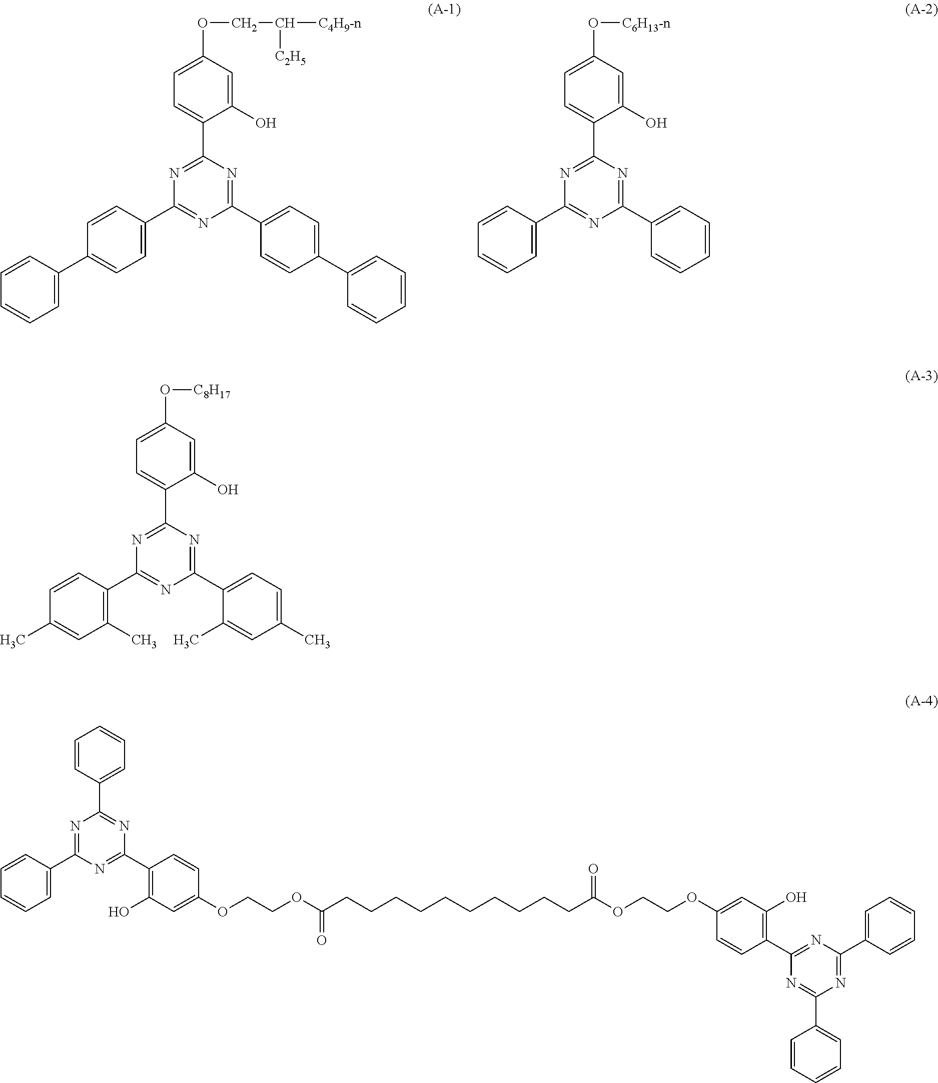 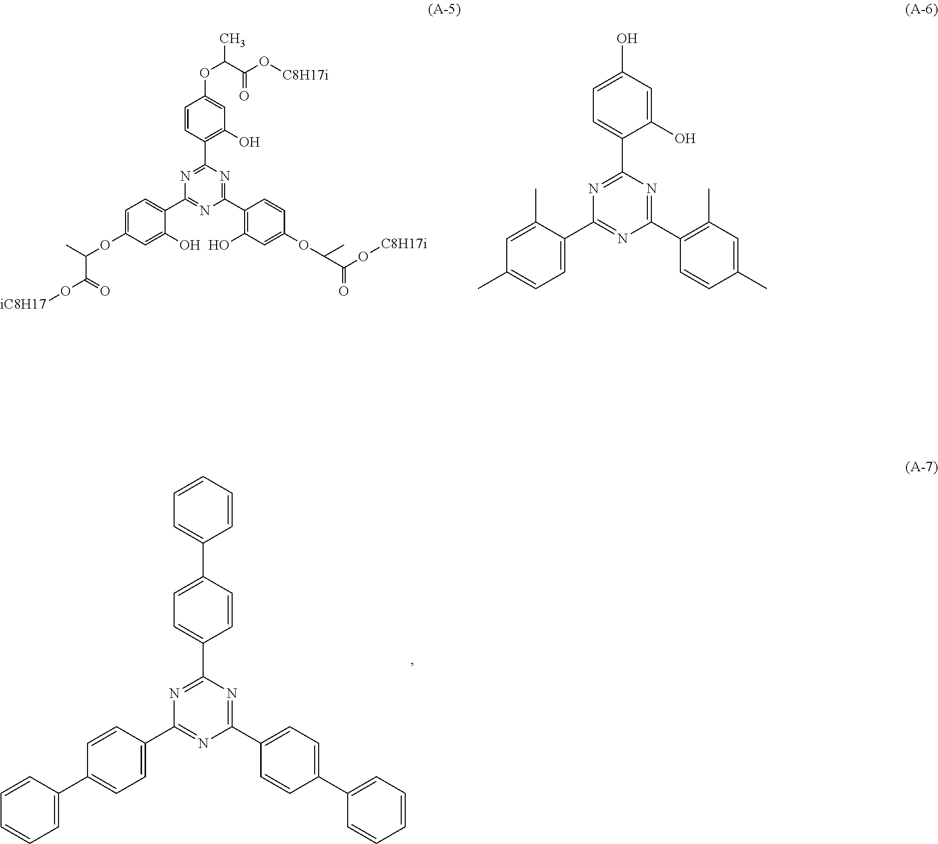
and
iii. at least one UV absorber, other than the compound of formula (A), in an amount in the range of 0.4 to 2.5 wt % based on the total weight of the composition.

2. The composition according to claim 1, wherein the polycarbonate is selected from homopolycarbonates, copolycarbonates, thermoplastic polyester carbonates, polycarbonate/acrylonitrile-butadiene-styrene terpolymer blend, thermoplastic alloy of polycarbonate/acrylic-styrene-acrylonitrile terpolymer, thermoplastic alloy blend of polycarbonate/polybutylene terephthalate, thermoplastic alloy of polycarbonate/polyethylene terephthalate, or thermoplastic alloy of polycarbonate, and or styrene-acrylonitrile.

3. The composition according to claim 1, wherein the UV absorber is selected from 2-(2′-hydroxyphenyl)benzotriazole, 2-hydroxybenzophenone, 2-(2-hydroxyphenyl)-1,3,5-triazine, cyanoacrylate, oxanilide, benzoxazinone, esters of substituted and unsubstituted benzoic acid, or mixtures of two or more thereof.

4. The composition according to claim 3, wherein 2-(2′-hydroxyphenyl)benzotriazole is selected from 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-meth-oxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy) carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole, 2-[2′-hydroxy-3′-(1,1,3,3-tetramethylbutyl)-5′-(α,α-dimethylbenzyl)-phenyl]benzotriazole, or mixtures of two or more thereof.

5. The composition according to claim 3, wherein 2-(2′-hydroxyphenyl)benzotriazole is selected from 2-(2′-hydroxy-5′-methylphenyl)-benzotriazole, 2,2′-methylene-bis[4-(1,1,3,3-tetramethylbutyl)-6-benzotriazole-2-ylphenol], 2-(3′,5′-bis-(α,α-dimethylbenzyl)-2′-hydroxyphenyl)benzotriazole, 2-(3′-tert-butyl-2′-hydroxy-5′-methylphenyl)-5-chloro-benzotriazole, or mixtures thereof.

6. The composition according to claim 3, wherein 2-hydroxybenzophenone is selected from 2-hydroxy-4-hydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4,2′,4′-trihydroxybenzophenone, 2-hydroxy-2′-hydroxy-4,4′-dimethoxybenzophenone derivatives, 1,4-bis(4-benzoyl-3-hydroxyphenoxy)-butane, or mixtures of two or more thereof.

7. The composition according to claim 3, wherein 2-(2-hydroxyphenyl)-1,3,5-triazine is selected from, other than the compounds of formula A, 2,4,6-tris(2-hydroxy-4-octyloxyphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydr-oxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-di-methylphenyl)-1,3,5-triazine, 2,4-bis(4-[2-ethylhexyloxy]-2-hydroxyphenyl)-6-(4-methoxyphe-nyl)-1,3,5-triazine, 2-[2-Hydroxy-4-[3-(2-ethylhexyl-1-oxy)-2-hydroxypropyloxy]phenyl]-4,6-bis(2,4-dimethylphenyl)-1,3,5-triazine, 5-Butoxy-2-[4-(4-butoxy-2-hydroxyphenyl)-6-(2,4-dibutoxyphenyl)-1,3,5-triazin-2-yl]phenol, 2-[4-[2-Hydroxy-3-tridecyloxypropyl]oxy]-2-hydroxyphenyl]-4,6-bis(2,4-dimethylphenyl)-1,3,5-triazine and 2-[4-[2-hydroxy-3-didecyloxypropyl]oxy]-2-hydroxyphenyl]-4,6-bis(2,4-dimethylphenyl)-1,3,5-triazine, Propanoic acid, 2-(4-(4,6-bis((1,1′-biphenyl)-4-yl)-1,3,5-triazin-2-yl)-3-hydroxyphenoxy)-, isooctyl ester, Bis-Ethylhexyloxyphenol Methoxyphenyl Triazine, or mixtures of two or more thereof.

8. The composition according to claim 3, wherein the cyanoacrylate UV absorber is selected from ethyl α-cyano-b,b-diphenylacrylate, isooctyl α-cyano-β,β-diphenylacrylate, neopentyl tetra(α-cyano-β,β-diphenylacrylate), pentaerythritol tetrakis(α-cyano-β,β-diphenylacrylate), ethyl 2-cyano-3,3-diphenylacrylate, (2-ethylhexyl)-2-cyano-3,3-diphenyl acrylate, or mixtures of two or more thereof.

9. The composition according to claim 3, wherein the cyanoacrylate UV absorber is pentaerythritol tetrakis(2-cyano-3,3-diphenylacrylate).

10. The composition according to claim 3, wherein the oxanilide is selected from 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl) oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides, mixtures of o- and p-ethoxy-disubstituted oxanilides, or mixtures of two or more thereof.

11. The composition according to claim 1, wherein the composition further comprises at least one antioxidant.

12. The composition according to claim 11, wherein the antioxidant is selected from phenolic antioxidant, organophosphorus stabilizer, or mixtures thereof.

13. The composition according to claim 11, wherein the phenolic antioxidant is selected from octadecyl-3-(3,5-di-tert-butyl-4-hydroxyphenyl)propionate, 1,3,5-tris(3,5-di-tert-butyl-4-hydroxybenzyl)-2,4,6-trimethylbenzene, N,N′-bis(3,5-di-tert-butyl-4-hydroxyphenylpropionyl)hexamethylene-diamide, 1,3,5-tris[3,5-di-tert-butyl-4-hydroxybenzyl]isocyanurate, 2,4-di-t-butylphenyl-3,5-di-t-butyl-4-hydroxybenzoate, bis(1,2,2,6,6-pentamethylpiperidin-4-yl)-butyl(3,5-di-t-butyl-4-hydroxybenzyl)malonate), blend of octadecyl-3-(3,5-di-tert-butyl-4-hydroxyphenyl)propionate and tris[2,4-di-tert-butylphenyl]phosphite, or mixtures of two or more thereof.

14. The composition according to claim 11, wherein the phenolic antioxidant is selected from octadecyl-3-(3,5-di-tert-butyl-4-hydroxyphenyl)propionate, or blend of octadecyl-3-(3,5-di-tert-butyl-4-hydroxyphenyl)propionate and tris[2,4-di-tert-butylphenyl]phosphite.

15. The composition according to claim 12, wherein the organophosphorus stabilizer is selected from organic phosphite, organic phosphonite, organic phosphine, or mixtures of two or more thereof.

16. The composition according to claim 15, wherein the organic phosphite is tris(2,4-di-tert-butylphenyl)phosphite.

17. The composition according to claim 15, wherein the organic phosphine is triphenylphosphine.

18. The composition according to claim 1, wherein the weight ratio of the total amount of compounds of formula (A) present in the composition to the total amount of UV absorber, other than the compound of formula (A), present in the composition is in the range of 1:50 to 50:1.

19. The composition according to claim 1, wherein the composition further comprises at least one sterically hindered amine light stabilizer.

20. The composition according to claim 19, wherein the sterically hindered amine light stabilizer is selected from carbonic acid bis(1-undecyloxy-2,2,6,6-tetramethyl-4-piperidyl) ester, bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, poly(4-hydroxy-2,2,6,6-tetramethyl-1-piperidineethanol-alt-1,4-butanedioic acid), linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino) ethane, the condensate of 2-chloro-4,6-di-(4-n-butylamino-1,2,2,6,6-pentamethylpiperidyl)-1,3,5-triazine and 1,2-bis(3-aminopropylamino) ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino) ethane and 2,4,6-trichloro-1,3,5-triazine and 4-butylamino-2,2,6,6-tetramethylpiperidine; a condensate of 1,6-hexanediamine and 2,4,6-trichloro-1,3,5-triazine as well as N,N-dibutylamine and 4-butylamino-2,2,6,6-tetramethylpiperidine; N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl) ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)amino)-s-triazine, N,N′-bis(2,2,6,6-tetramethyl-4-piperidyl)-N,N′-diformylhexamethylenediamine, mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidineethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, 1,6-Hexanediamine, N¹,N⁶-bis(2,2,6,6-tetramethyl-4-piperidinyl)-, polymers with morpholine-2,4,6-trichloro-1,3,5-triazine reaction products, methylated. 1,6-Hexanediamine, N¹,N⁶-bis(2,2,6,6-tetramethyl-4-piperidinyl)-, polymer with 2,4-dichloro-6-(4-morpholinyl)-1,3,5-triazine, mixture of 1,6-Hexanediamine, N¹,N⁶-bis(2,2,6,6-tetramethyl-4-piperidinyl)-, polymers with morpholine-2,4,6-trichloro-1,3,5-triazine reaction products, methylated and 2-(4,6-Bis-(2,4-dimethylphenyl)-1,3,5-triazin-2-yl)-5-(octyloxy)-phenol, mixture of 1,6-Hexanediamine, N¹,N⁶-bis(2,2,6,6-tetramethyl-4-piperidinyl)-, polymer with 2,4-dichloro-6-(4-morpholinyl)-1,3,5-triazine and 2-(4,6-Bis-(2,4-dimethylphenyl)-1,3,5-triazin-2-yl)-5-(octyloxy)-phenol, or mixtures of two or more thereof.

21. The composition according to claim 19, wherein the sterically hindered amine light stabilizer is selected from mixture of bis(1,2,2,6,6-pentamethyl-4-piperidyl) sebacate and 1-(methyl)-8-(1,2,2,6,6-pentamethyl-4-piperidyl) sebacate, mixture of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane and Poly(4-hydroxy-2,2,6,6-tetramethyl-1-piperidine ethanol-alt-1,4-butanedioic acid), Bis(1,2,2,6,6-pentamethyl-4-piperidinyl)-2-butyl-2-(4-hydroxy-3,5-di-tert.butylbenzyl) propanedioate, bis(2,2,6,6-tetramethyl-4-piperidyl) sebacate, bis(1-octyloxy-2,2,6,6-tetramethylpiperidyl) sebacate, mixture of 1-(2-hydroxy-2-methylpropoxy)-4-octadecanoyloxy-2,2,6,6-tetramethylpiperidine and 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, or mixtures of two or more thereof.

22. The composition according to claim 1, wherein the composition further comprises at least one compound of formula (B) of general formula (I), general formula (II), general formula (III) or general formula (IV)
compound (B) of General Formula (I) 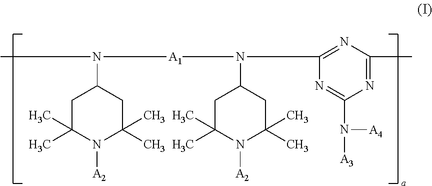
wherein
A₁ is independently selected from linear or branched, substituted or unsubstituted C₂-C₁₈ alkylene, substituted or unsubstituted C₅-C₇ cycloalkylene and C₁-C₄ alkylenedi (C₅-C₇ cyclo alkylene),
A₂ is independently selected from H, linear or branched, substituted or unsubstituted C₁-C₁₂ alkyl, C₁-C₁₂ alkyloxy, substituted or unsubstituted C₅-C₁₂ cycloalkyl and C₅-C₁₂cycloalkyloxy,
A₃ and A₄ are independently selected from H, linear or branched, substituted or unsubstituted C₁-C₁₂ alkyl, substituted or unsubstituted C₅-C₁₂ cycloalkyl and a group of the formula (a-1), 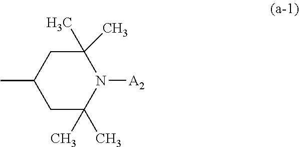
or
A₃ and A₄, together with the nitrogen atom to which they are bonded, form a 5- to 10-membered heterocyclic ring; and
a is an integer in the range of 1 to 20 and the repeating units are the same or different;
compound (B) of General Formula (II) 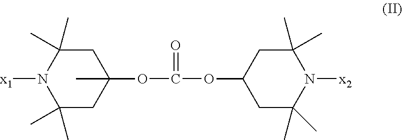
wherein
x₁ and x₂ is independently selected from C₁ to C₃₀ alkoxy,
compound (B) of General Formula (III) 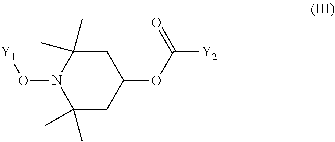
wherein
Y₁ is linear or branched, substituted or unsubstituted C₃ to C₂₀ alkyl,
Y2 is C₁ to C₃₀ alkyl; and
compound (B) of General Formula (IV) 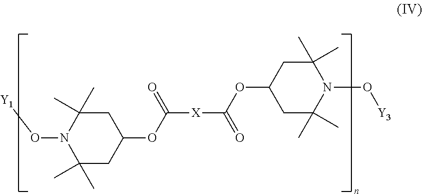
wherein
Y₁ is linear or branched, substituted or unsubstituted C₃ to C₂₀ alkyl,
Y₃ is independently selected from linear or branched, substituted or unsubstituted C₃ to C₂₀ alkyl, and C₃ to C₂₀ alkylidene,
X is C₂ to C₈ alkyl,
n is an integer in the range of 1 to 8.

23. The composition according to claim 22, wherein the compound of formula (B) is selected from the formulae (B-1), (B-2), (B-3), (B-4), (B-5), (B-6), (B-7), (B-8), or mixtures of two or more thereof: 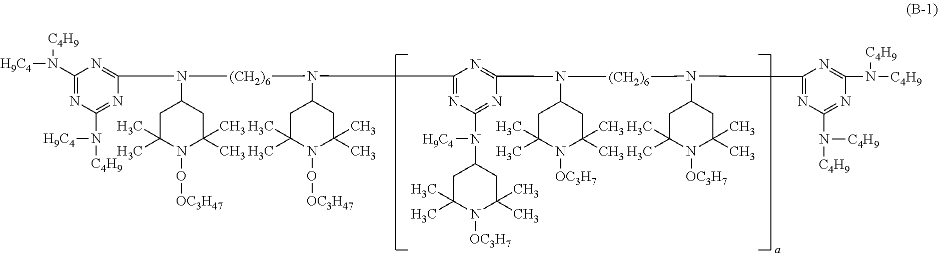
wherein a is an integer in the range of 1 to 10;

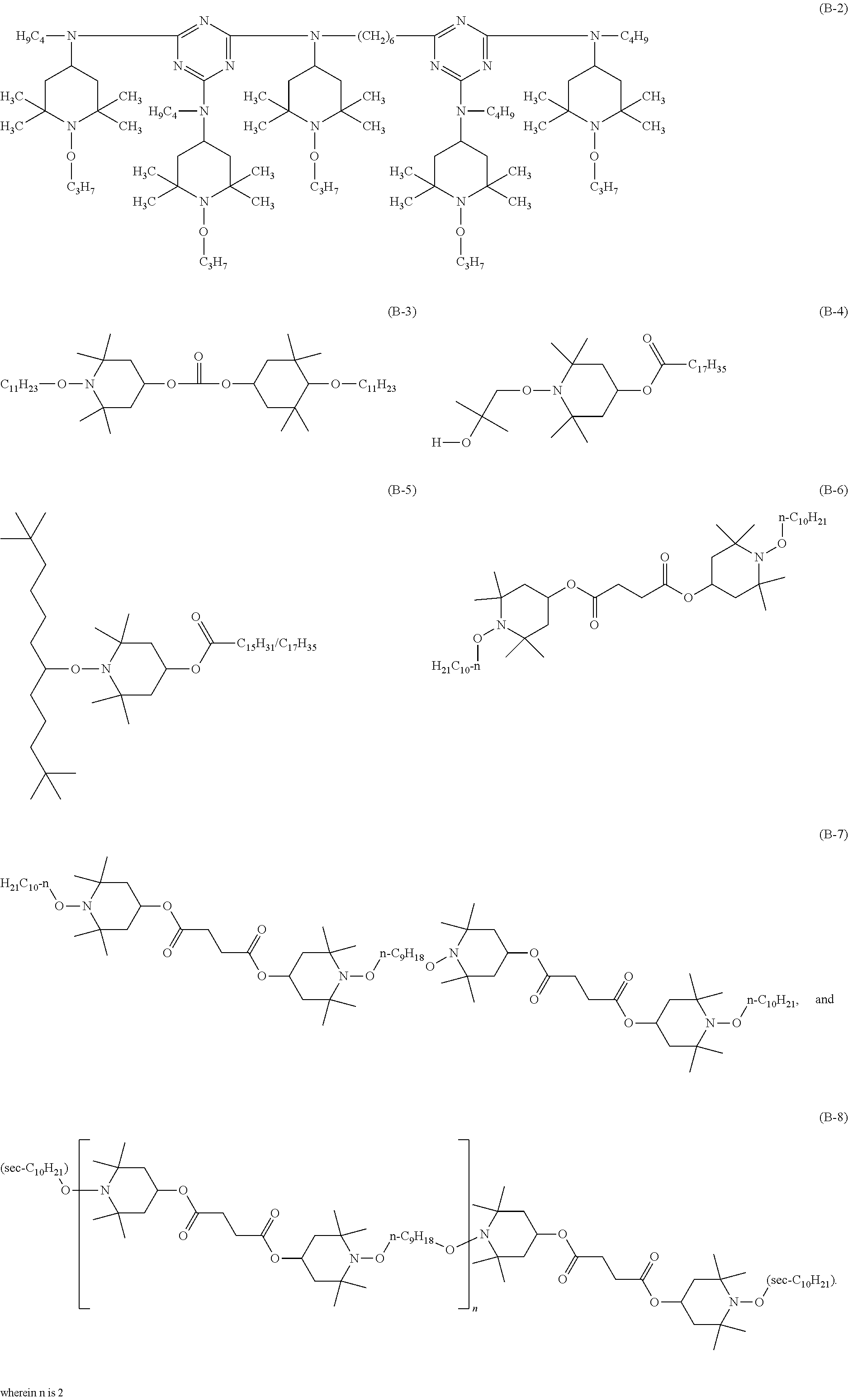

24. The composition according to claim 1, wherein the composition further comprises at least one additive selected from anti-scratch agents, slip agents, anti-block agents, thermal fillers, pigments, anti-fog, or anti-mist agents.

25. An additive mixture comprising:
at least one compound of formula (A) as defined in claim 1; and
at least one UV absorber selected from 2-(2′-hydroxyphenyl)benzotriazole, 2-hydroxybenzophenone, 2-(2-hydroxyphenyl)-1,3,5-triazine, cyanoacrylate, oxanilide, benzoxazinone, esters of substituted and unsubstituted benzoic acid, or mixtures of two or more thereof.

26. (canceled)

27. An article comprising the composition according to claim 1.

28. (canceled)
